(19) United States
(12) Patent Application Publication
(10) Pub. No.: US 2023/0355465 A1
(43) Pub. Date: Nov. 9, 2023

(54) ERGONOMIC ELECTRIC MUSCLE MASSAGER

(71) Applicant: All Contours Massagers LLC, Chicago, IL (US)

(72) Inventor: Dariusz DYLAG, Chicago, IL (US)

(21) Appl. No.: 18/144,829

(22) Filed: May 8, 2023

Related U.S. Application Data
(60) Provisional application No. 63/339,398, filed on May 6, 2022.

(51) Int. Cl. A61H 23/02

(52) U.S. Cl. CPC A61H 23/02; A61H 2201/1685; A61H 2201/5025

(57) ABSTRACT

An ergonomic electric muscle massager. The ergonomic electric muscle massager may be cordless, have interchangeable parts, vibrate, and contort to the user's body. The ergonomic electric muscle massager may have a front end that has a series of compressible tips that allow the ergonomic electric muscle massager to conform to and glide along the user's body. The body of the ergonomic electric muscle massager may also have contours and a vibration action which allow the ergonomic electric muscle massager's body to massage the user.

### CROSS-REFERENCE TO RELATED APPLICATIONS

This application claims benefit of Ser. No. 63/339,398 filed May 6, 2022, with the same title, which is incorporated by reference as if fully restated herein.

### FIELD OF THE DISCLOSURE

The present invention relates generally to an ergonomic electric muscle massager comprising interchangeable heads and can contort to any part of the user's body.

### BACKGROUND OF THE DISCLOSURE

Muscle aches, pains, and tightness are common ailments, especially for those performing manual labor, physical fitness training, and those who are forced to maintain sitting and standing positions for extended periods of time. Receiving muscle massages from licensed massage practitioners can be fairly expensive and time consuming.

In an effort to simulate a muscle massage, various muscle massage devices have been created. Many of the initial devices were nothing more than stationary pieces of plastic for the user to lay across in various positions. Since then, similar devices in various size and shapes have been created to massage different muscles in different ways. Some devices required two hands to operate while others allowed for single hand operation. Many have rolling capabilities while others slide across the skin.

Eventually, muscle massagers would become electric rather than purely mechanical in nature. Various designs, such as the famous electric massage chair, converted electricity into mechanical energy by employing various motors and rollers to massage the body. This would lead to more compact and hand-held designs comprising some aspect of vibration, piston action, and/or rotation action. However, many of such electric massagers are still rather large and unwieldly, often requiring another to operate it in order to massage certain points of the body, like the back. In addition, such electric muscle massagers are designed from the perspective of having a single point of contact, wasting much of the design of the device to merely store the electrical components with no other practical purpose geared towards the massage itself. Further, many designs remain too heavy to operate with only a single hand and do not allow for portable, wireless use.

Accordingly, there is a long felt need for an electric muscle massager that allows the user to operate it either one-handed or hands free, wherein the entirety of the device's body is ergonomic in nature towards massaging various parts of the body and is entirely wireless and rechargeable.

### SUMMARY OF THE DISCLOSURE

The present invention is directed to an ergonomic electric muscle massager.

The electric massager comprises a housing body with a front end and a rear end. A head can be attached to the front end and a back can be attached to the rear end. A power supply, motor, and switch are connected by a circuit and are stored inside the housing body and are accessible by the rear end. The head can hold a plurality of removable, compressible massaging tips, with each removable, compressible massaging tip further comprising a ball bearing allowing the removable, compressible massaging tips to slide along the user's skin. An activation mechanism can placed on the housing body which engages with the switch of the inner circuit, either turning the motor on or off.

When the motor is switched on, the electric muscle massager can vibrate. The user can use any part of the electric muscle massager to massage parts of their body. One method of operation involves taking the electric muscle massager in hand and placing the removable, compressible massaging tips along the desired part of the body to be massaged. The removable, compressible massaging tips can retract into the head, allowing the head to conform to any shape of the user's body.

In a first implementation of the invention, the electric muscle massager's head can be exchanged or replaced with a second head. This second head can hold entirely different massaging components from the removable, compressible massaging tips, for example, variously sized massage balls and/or ball bearings. In this implementation, the ergonomic electric massager also further comprises a neck with its own front end and a rear end, wherein the rear end of the neck can be attached to the front end of the housing body and the front end of the neck can be attached to the head. Also in this implementation, the point of contact between the neck and head allows the head to bend at various angles.

Also in this implementation, the shape of the housing body features many smooth convex and concave curves. Thus, another method of operation involves taking the ergonomic electric massager and applying a point on the housing body to the user's skin either by maintaining stable contact, sliding the housing body along the user's skin, or rolling the housing body along the user's skin. In this method of operation, the vibration action of the ergonomic electric massager massages the desired point of the user's body. In either method of operation, the ergonomic electric massager can be operated with either a one hand or no hands (e.g., allowing the housing body of the ergonomic electric massager to massager joints of the user, such as the inner elbow joints, inner knee joints, neck joints, etc.; or by placing the ergonomic electric massager on the ground and laying various parts of the users body along it).

In another implementation of the invention, the housing body consists of a large step-on box rather than a hand-held ergonomic device. In this implementation, the housing body can be a large box comprising a top end, a rear end, and several sides connecting the top end to the rear end. In this implementation, rows and columns of removable, compressible massaging tips can line the top end of the housing body. In addition, this implementation also has a vibrating action that can be activated by a power supply and motor connected by a switch with an activation mechanism which may be placed on one of the sides of the housing body. The housing body can hold several hundreds of pounds of weight, allowing the user to stand atop the housing body to massage their feet. While atop the housing body, the removable, compressible massaging tips retract into the housing body contorting the top end to the user's feet. Alternatively, the housing body can be wide enough to allow a user to lay atop of it, allowing the housing body to massage the entirety of the user's back or front-facing abdomen at once. In this implementation, the top end of the housing body can be removed and replaced with other top ends that will allow for massage components entirely distinct from the removable, compressible massaging tips (e.g., large rollable balls and ball bearings).

In all implementations of the invention, the components of the of the ergonomic electric massager (other than the power supply and motor) may be made out of metal, metal alloys and/or polymers.

These and other objects, features, and advantages of the present invention will become more readily apparent from the attached drawings and the detailed description of the preferred embodiments, which follow.

### BRIEF DESCRIPTION OF THE DRAWINGS

The disclosed embodiments of the invention will hereinafter be described in conjunction with the appended drawings provided to illustrate, and not to limit the invention, where like designations denote like elements, and in which:

FIG. 1 is a perspective view of an exemplary embodiment of the ergonomic electric massager as described in the present disclosure;

FIG. 2 is a perspective view of an exemplary embodiment of the ergonomic electric massager as described in the present disclosure;

FIG. 3 is top-down perspective view of an exemplary embodiment of the ergonomic electric massager as described in the present disclosure;

FIG. 4 is a front-end perspective view of an exemplary embodiment of the ergonomic electric massager as described in the present disclosure;

FIG. 5 is a close-up perspective view of an exemplary embodiment of the ergonomic electric massager as described in the present disclosure, detailing the removable, compressible massaging tips;

FIG. 6 is a close-up perspective view of an exemplary embodiment of the ergonomic electric massager as described in the present disclosure, detailing the top of the head of the ergonomic electric massager with the removable, compressible massaging tips removed;

FIG. 7 is a close-up perspective view of an exemplary embodiment of the ergonomic electric massager as described in the present disclosure, detailing the bottom of the head of the ergonomic electric massager;

FIG. 8 is a perspective view of an exemplary embodiment of the ergonomic electric massager as described in the present disclosure, detailing the body of the ergonomic electric massager with the head removed;

FIG. 9 is a perspective view of an exemplary embodiment of the ergonomic electric massager as described in the present disclosure, detailing an accessory for the removal of removable, compressible massage tips from the ergonomic electric massager;

FIG. 10 is a perspective view of an exemplary embodiment of the ergonomic electric massager as described in the present disclosure, detailing the accessory for the removal of removable, compressible massage tips while in use on the ergonomic electric massager;

FIG. 11 is a perspective view of an alternate head of the ergonomic electric massager as described in the present disclosure;

FIG. 12 is a perspective view of the alternate head of the ergonomic electric massager as described in the present disclosure, detailing the top of the alternate head of the ergonomic electric massager with some of the removable, massaging ball bearings removed;

FIG. 13 is a perspective view of an alternate head and an extended attachment neck of the ergonomic electric massager as described in the present disclosure, demonstrating how the alternate head connects to the extended attachment neck of the ergonomic electric massager;

FIG. 14 is a perspective view of an exemplary embodiment of the ergonomic electric massager as described in the present disclosure, detailing a strap accessory to be used on the ergonomic electric massager;

FIG. 15 is a top-down perspective view of an exemplary embodiment of the ergonomic electric massager as described in the present disclosure, detailing the strap accessory while in use on the ergonomic electric massager;

FIG. 16 is a top-down perspective view of an exemplary embodiment of the ergonomic electric massager as described in the present disclosure, detailing the strap accessory while in use on the ergonomic electric massager;

FIG. 17 is a close-up perspective view of an exemplary embodiment of the ergonomic electric massager as described in the present disclosure, detailing the top of the head of the ergonomic electric massager with the removable, compressible massaging tips;

FIG. 18 is a close-up perspective view of an exemplary embodiment of the ergonomic electric massager as described in the present disclosure, detailing the top of the head of the ergonomic electric massager with the removable, compressible massaging tips;

FIG. 19 is a perspective view of an exemplary embodiment of the ergonomic electric massager as described in the present disclosure, demonstrating the top of the ergonomic electric massager being used to massage a user's outer knee;

FIG. 20 is a perspective view of an exemplary embodiment of the ergonomic electric massager as described in the present disclosure, demonstrating the body of the ergonomic electric massager being used to massage the user's hand;

FIG. 21 is a perspective view of an exemplary embodiment of the ergonomic electric massager as described in the present disclosure, demonstrating the body of the ergonomic electric massager being used to massage the user's inner elbow;

FIG. 22 is a perspective view of an exemplary embodiment of the ergonomic electric massager as described in the present disclosure, demonstrating the body of the ergonomic electric massager being used to massage the user's upper arm;

FIG. 23 is a perspective view of an exemplary embodiment of the ergonomic electric massager as described in the present disclosure, demonstrating the body of the ergonomic electric massager being used to massage the user's upper arm;

FIG. 24 is a perspective view of an exemplary embodiment of the ergonomic electric massager as described in the present disclosure, demonstrating the body of the ergonomic electric massager being used to massage the user's calf;

FIG. 25 is a perspective view of an exemplary embodiment of the ergonomic electric massager as described in the present disclosure, demonstrating the body of the ergonomic electric massager being used to massage the user's ankle;

FIG. 26 is a perspective view of an exemplary embodiment of the ergonomic electric massager as described in the present disclosure, demonstrating the body of the ergonomic electric massager being used to massage the user's ankle;

FIG. 27 is a perspective view of an exemplary embodiment of the ergonomic electric massager as described in the present disclosure, demonstrating the body of the ergonomic electric massager being used to massage the user's lower leg;

FIG. 28 is a top-down perspective view of an exemplary embodiment of the ergonomic electric massager as described in the present disclosure;

FIG. 29 is a side perspective view of an exemplary embodiment of the ergonomic electric massager as described in the present disclosure;

FIG. 30 is a perspective view of an exemplary embodiment of the ergonomic electric massager as described in the present disclosure;

FIG. 31 is a top-down perspective view of an exemplary embodiment of the ergonomic electric massager as described in the present disclosure;

FIG. 32 is a side perspective view of an exemplary embodiment of the ergonomic electric massager as described in the present disclosure;

FIG. 33 is a close-up perspective view of an exemplary embodiment of the ergonomic electric massager as described in the present disclosure;

FIG. 34 is a close-up perspective view of an exemplary embodiment of the ergonomic electric massager as described in the present disclosure;

FIG. 35 is a perspective view of an exemplary embodiment of the ergonomic electric massager as described in the present disclosure, detailing an accessory to be used on the ergonomic electric massager;

FIG. 36 is a front elevation view of an exemplary embodiment of a removable head; and

FIG. 37 is a schematic of a second exemplary embodiment of an ergonomic electric massager for as described in the present disclosure.

Like reference numerals refer to like parts throughout the several views of the drawings.

### DETAILED DESCRIPTION

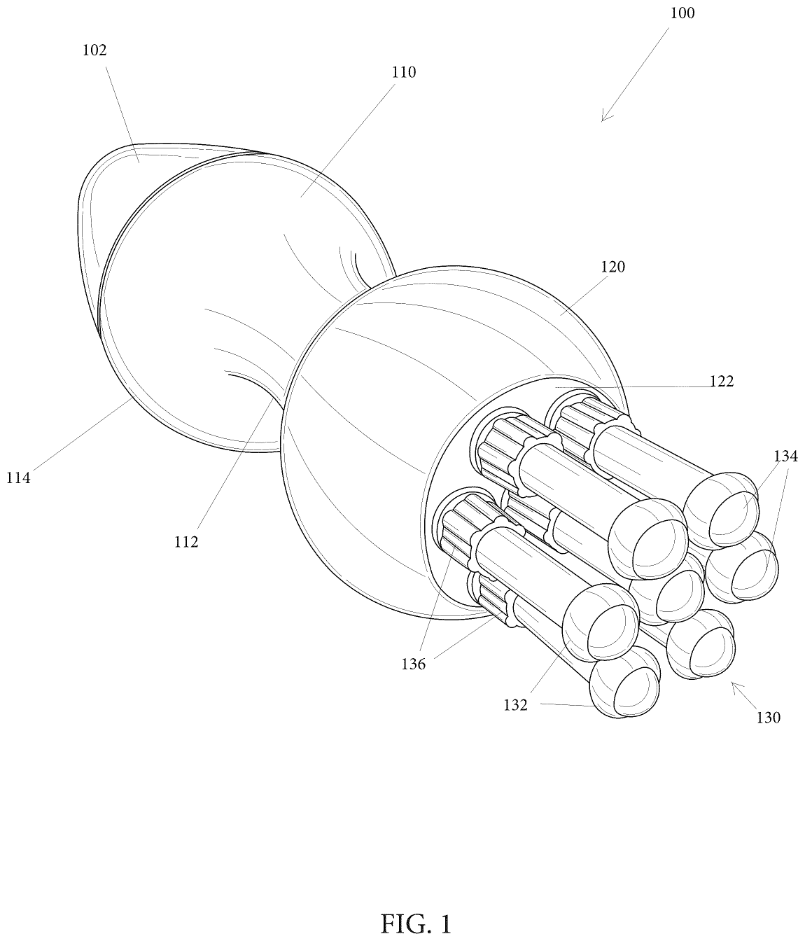

The invention is defined by the claims. The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed toward an ergonomic electric massager.

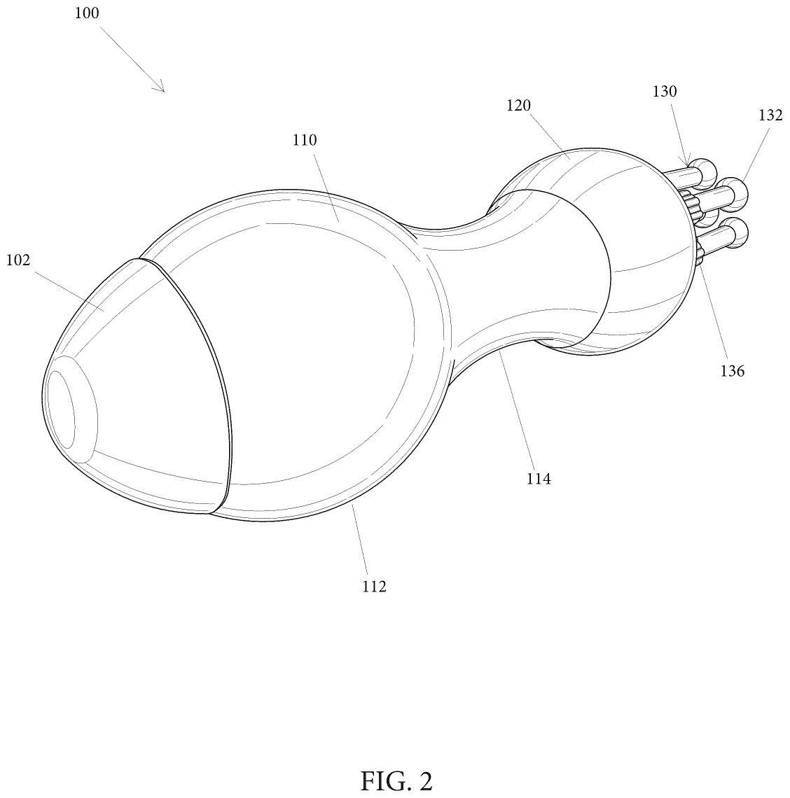

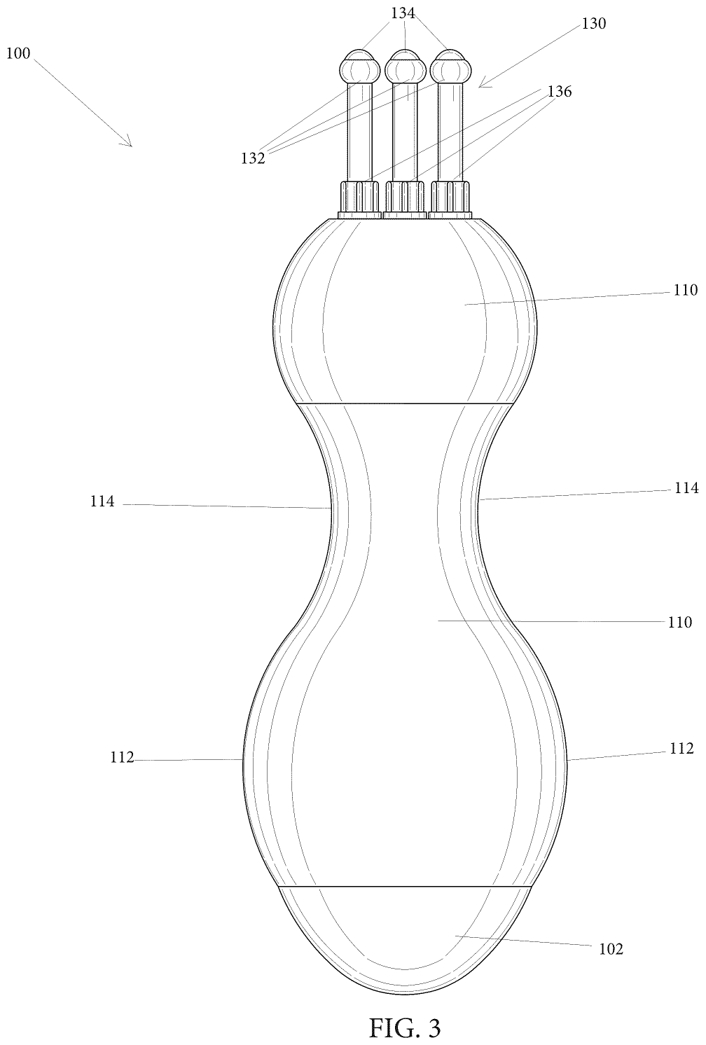

Referring to FIGS. 1-27, a first exemplary embodiment of an ergonomic electric massager 100 is illustrated in accordance with a first exemplary embodiment of the present invention.

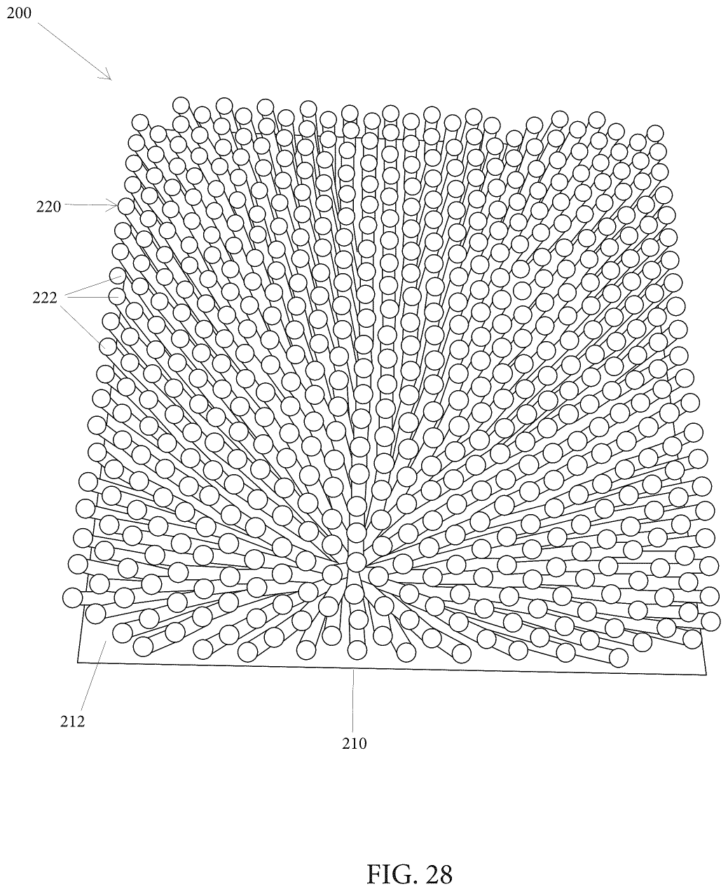

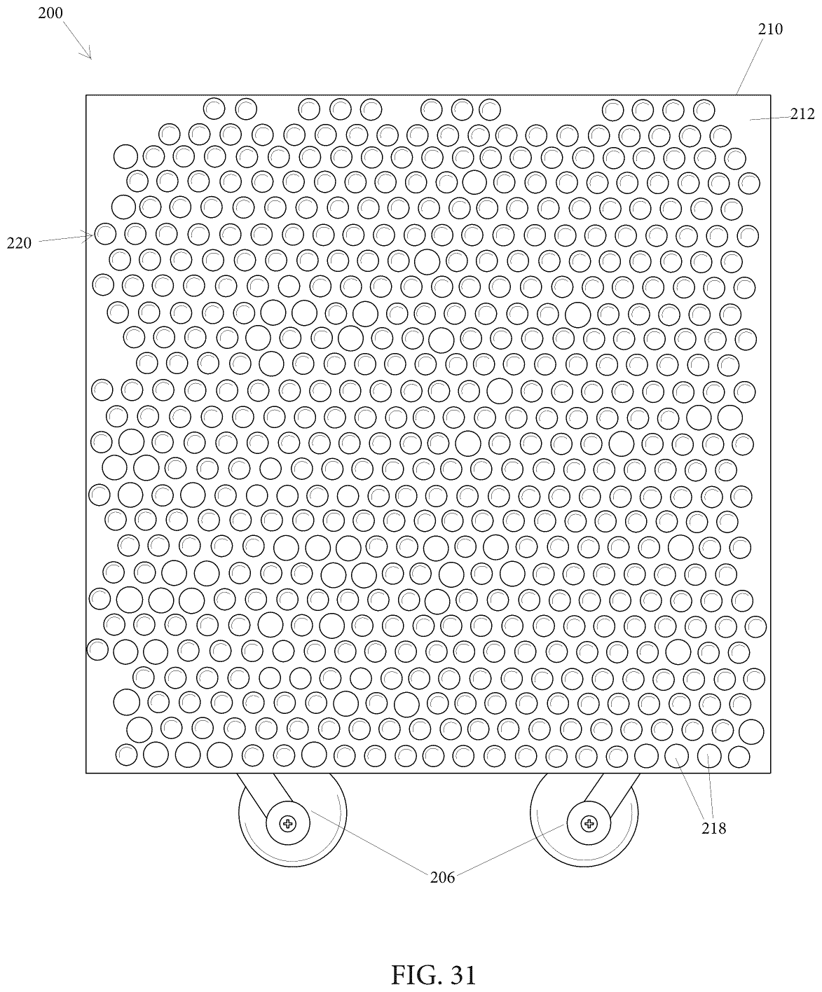

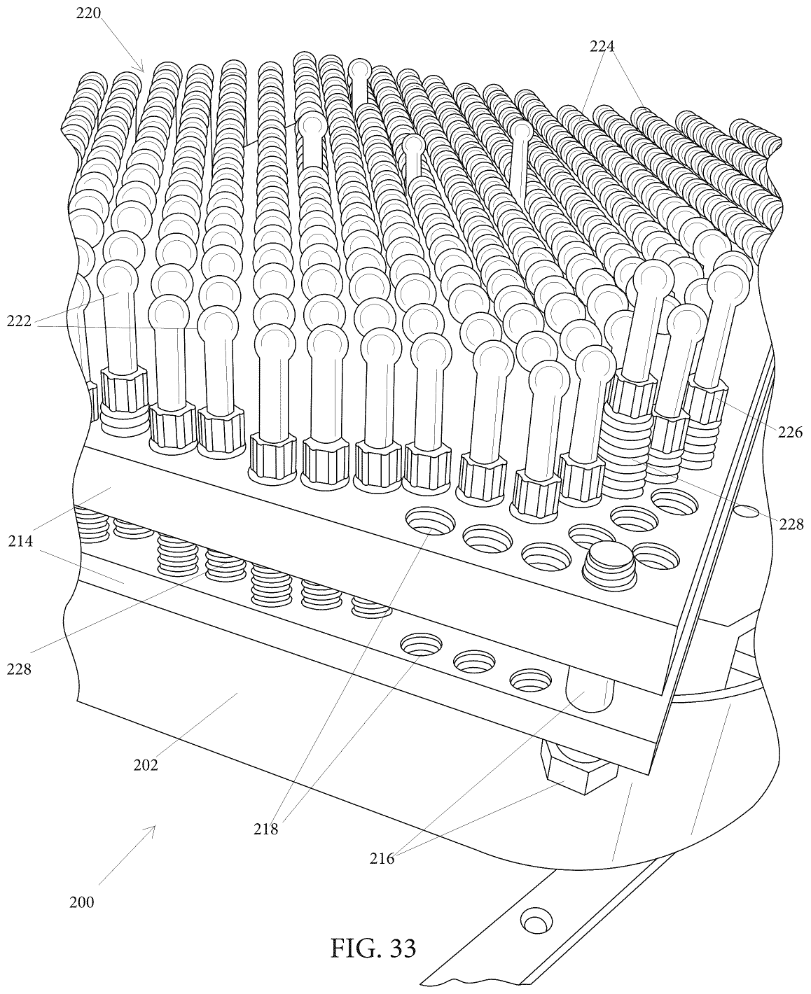

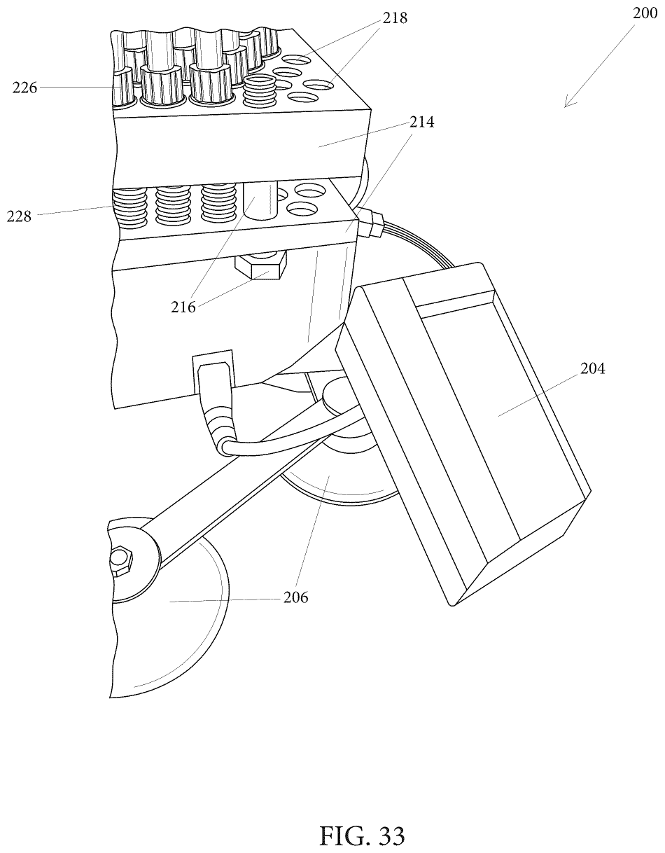

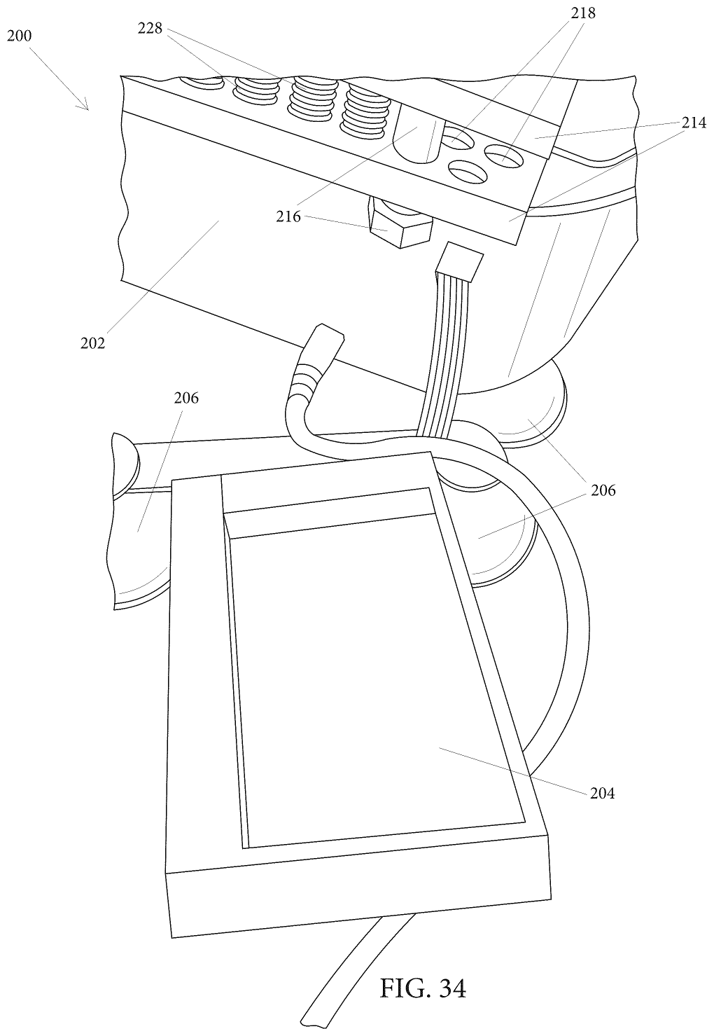

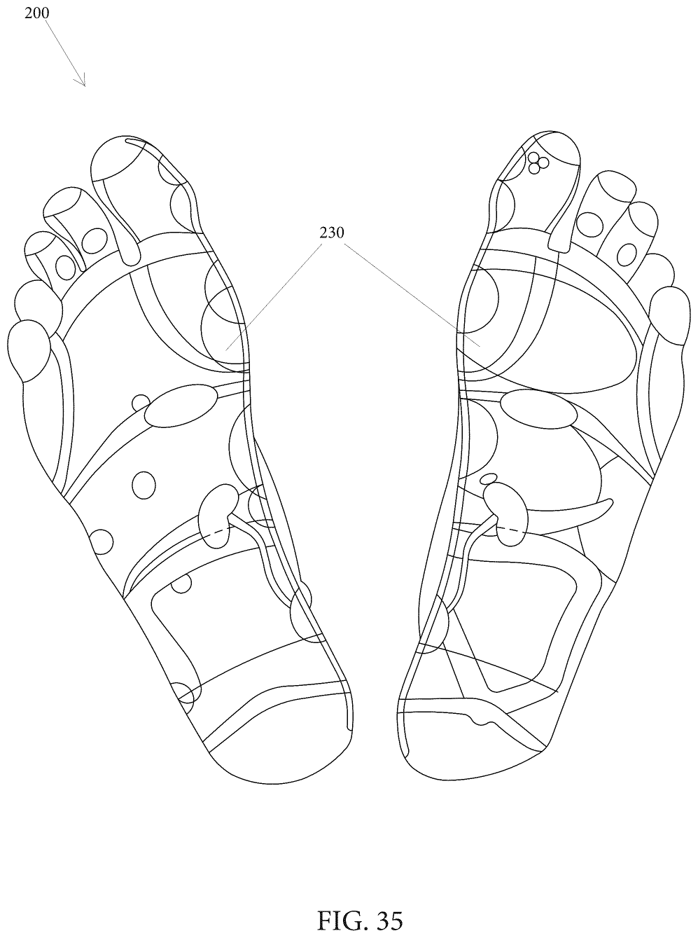

Referring to FIGS. 28-35, a second exemplary embodiment of an ergonomic electric massager 200 is illustrated in accordance with a second exemplary embodiment of the present invention.

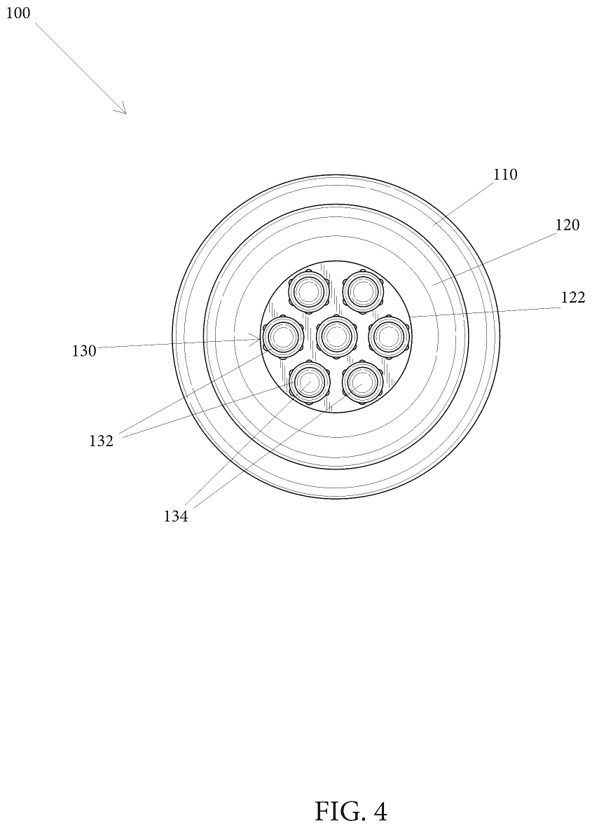

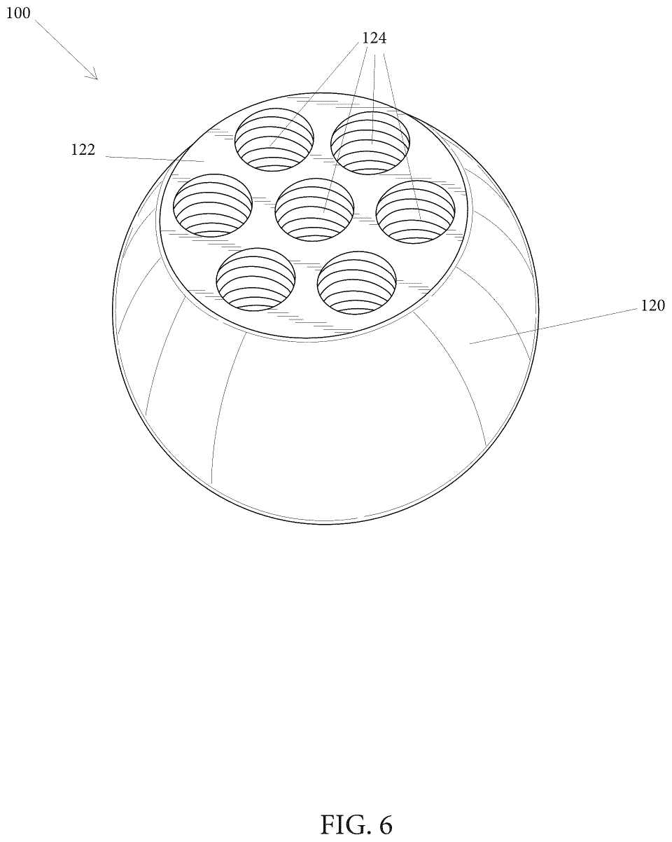

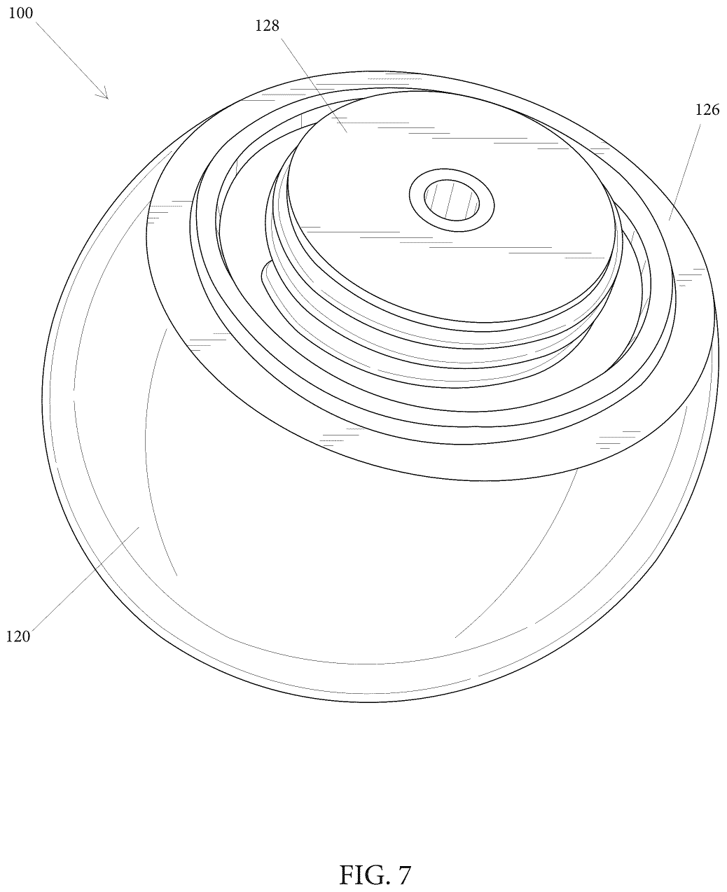

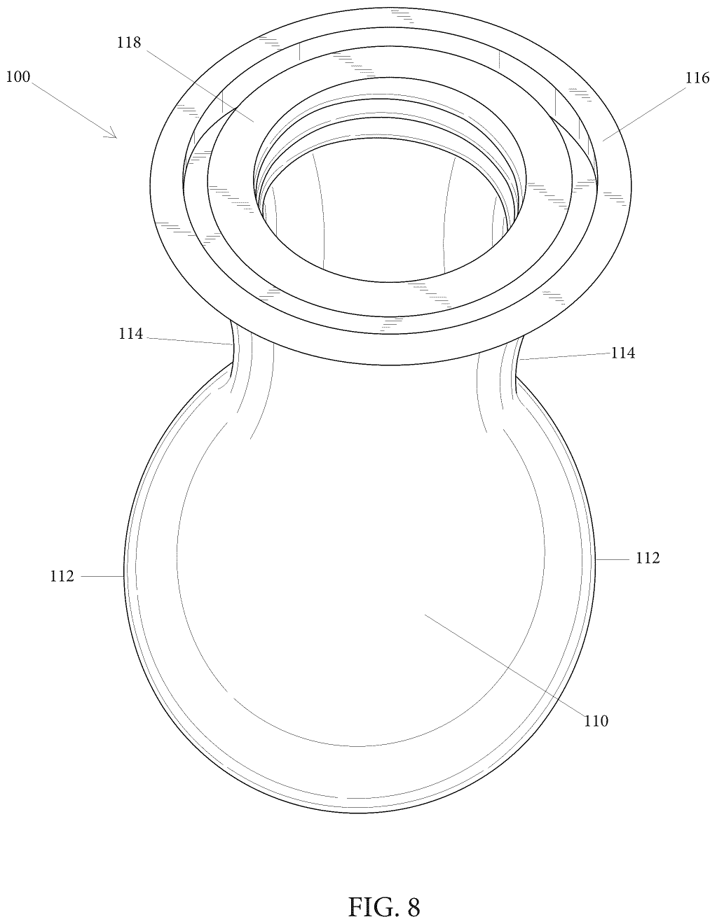

As shown for instance in FIGS. 1-4, the first exemplary embodiment of an ergonomic electric massager 100 can comprise a removable back plate 102, a first body 110, and a first removable head 120. The removable back plate 102 can comprise a removable back plate bottom side, not shown, and a removable back plate connector, not shown. The first body 110 can comprise at least one first body concave contour 114, as shown in FIGS. 1-3; at least one first body convex contour 112, as shown in FIGS. 1-3; a first body top side 116, as shown in FIG. 8; a first body bottom side, not shown; a head connector slot 118, as shown in FIG. 8; and a back plate connector slot, not shown. The first removable head 120 can comprise a first removable head top side 122, as shown in FIG. 4; a plurality of first removable head insert slots 124, as shown in FIG. 6; a first removable head back side 126, as shown in FIG. 7; and a first removable head connector 128, as shown in FIG. 7.

The first body 110 when engaged with the removable back plate 102 can be designed to have a smooth uniform curvature resembling the shape of a hyperbolic hyperboloid in congruence to a paraboloid, as shown in FIGS. 1-3. The shape of the first body 110 can have at least one first body concave contour 114, as shown in FIGS. 1-3; at least one first body convex contour 112, as shown in FIGS. 1-3 so that the body can be comfortably placed and rolled along various parts of the user's body. In alternative exemplary embodiments, the first body 110 and removable back plate 102 can have various shapes. Further, due to the vibration action of the motor, the first body 110 itself can be used to massage parts of the user's body, and due to the first body convex contour 112, first body concave contour 114, and the shape of the removable back plate 102, any portion of the first exemplary embodiment of the ergonomic electric massager 100 can massage the user's body.

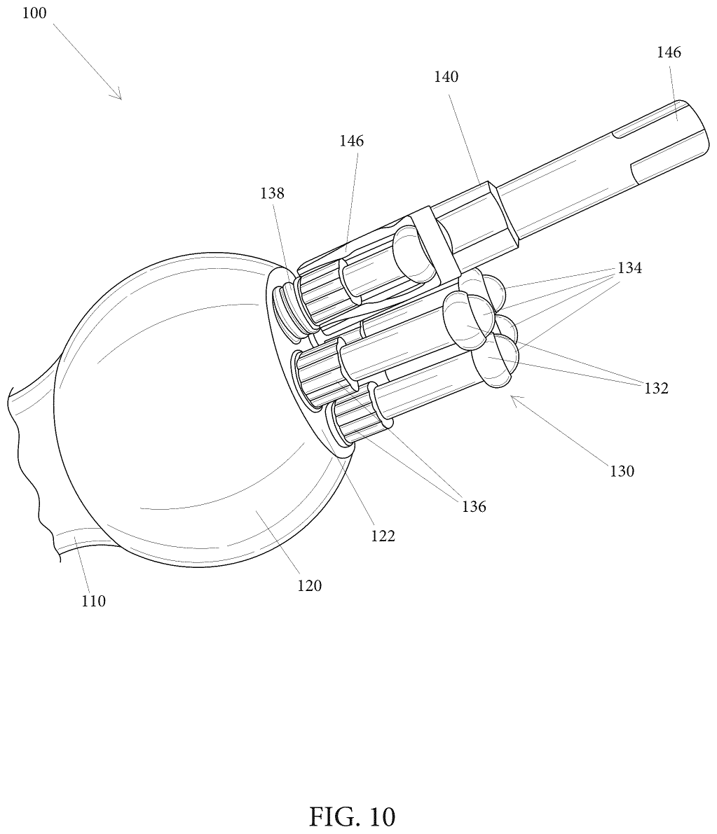

A plurality of first removable, compressible massage tips 130 can be inserted into the plurality of first removable head insert slots 124, as shown in FIGS. 1-5. The plurality of first removable, compressible massage tips 130 can each comprise a first removable, compressible massage tip head 132; a first removable, compressible massage tip ball bearing 134, a first removable, compressible massage tip base 136, a first removable, compressible massage tip connector 138, as shown in FIG. 10, and a first removable, compressible massage tip spring, not shown.

Inside the first exemplary embodiment of the ergonomic electric massager 100 can be a circuit, not shown, connecting a power supply, not shown, to a motor, not shown, and a switch, not shown. The circuit can comprise any number of resistors, capacitors, transistors, parallel circuits, and sequential circuits to make operation of the first exemplary embodiment of the ergonomic electric massager 100 run as efficiently as possible. The power supply may be any sort of fixed (e.g., a plug for a wall outlet) or portable power supply, such as, but not limited to, lead-acid, zinc-air, nickel-cadmium, nickel-metal hydride, lithium-ion, lithium iron phosphate, and lithium-ion polymer. The power supply may be either disposable in nature or rechargeable in nature. The motor may be any sort of compact and portable motor that allows for the vibration of the first exemplary embodiment of the ergonomic electric massager 100. Alternatively, the motor may operate a separate vibrating device, wherein the vibrating device may be either electric, mechanical, or electromechanical in nature. Further, the circuit, not shown, may have any number of sub-circuits, not shown, to allow the user to vary the strength in vibration. Any technique to vary in strength of the vibrations may be employed, including, but not limited to, using parallel circuits to amplify the current of the circuit and using this amplified current to signal the motor to increase the rpms of its moving components. In such an embodiment, the switch, not shown, may be a rotating dial instead of a singular flip switch to allow the user to turn on the first exemplary embodiment of the ergonomic electric massager 100 and then cycle through the various vibration settings before switching the first exemplary embodiment of the ergonomic electric massager 100 off.

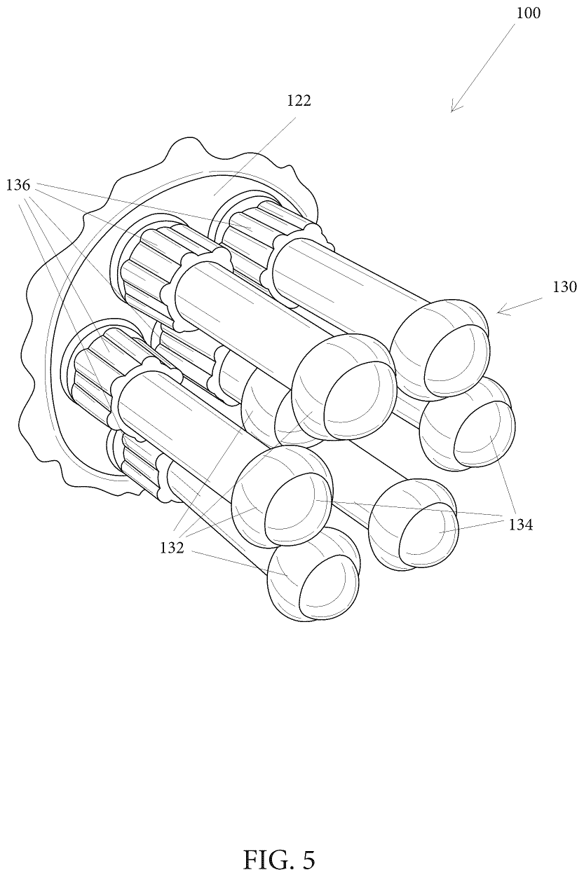

FIG. 5 details the plurality of first removable, compressible massage tips 130—as well as their components—in the first exemplary embodiment of the ergonomic electric massager 100. The plurality of first removable, compressible massage tips 130 can be inserted into the plurality of first removable head insert slots 124, as shown in FIGS. 1-5. The plethora of first removable, compressible massage tips 130 can each comprise a first removable, compressible massage tip head 132; a first removable, compressible massage tip ball bearing 134; a first removable, compressible massage tip base 136; a first removable, compressible massage tip connector 138, as shown in FIG. 10, and a first removable, compressible massage tip spring, not shown.

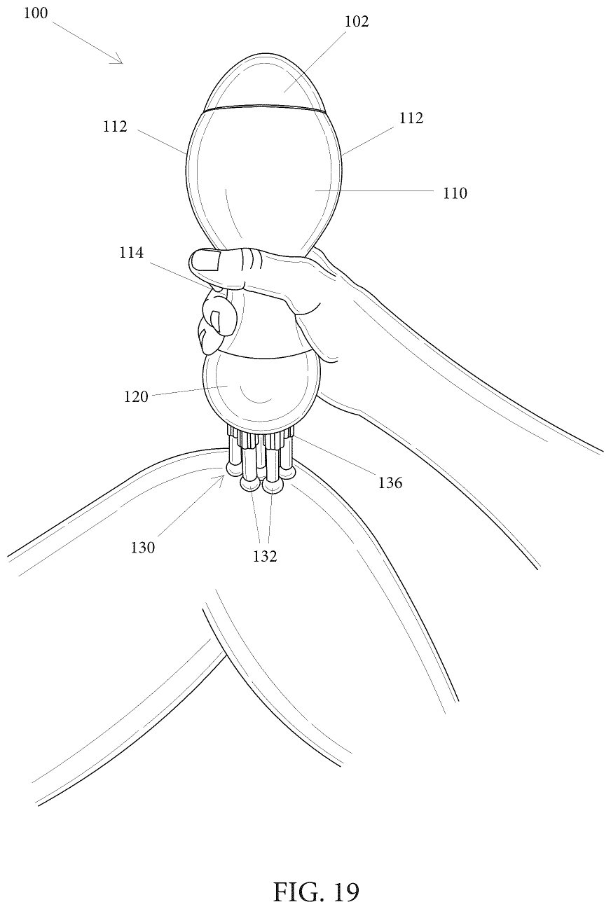

For each of the first removable, compressible massage tips 130, the first removable, compressible massage tip spring, not shown, can be placed inside a first removable head insert slot 124, and then the first removable, compressible massage tip base 136 can be engaged with first removable head insert slot 124 by the first removable, compressible massage tip connector 138. The form of engagement can be any sort of engagement that allows the first removable, compressible massage tip connector 138 to remain securely attached to the first removable head insert slot 124, including, but not limited to, a screw thread engagement. Each first removable, compressible massage tip base 136 and first removable, compressible massage tip connector 138 can be hollow allowing for the first removable, compressible massage tip 130 to move through the first removable, compressible massage tip base 136 and into the first removable head insert slot 124 up to the first removable, compressible massage tip head 132. Thus, each of the first removable, compressible massage tips 130 can be compressed into a first removable head insert slot 124 up to the first removable, compressible massage tip head 132 when a force is applied to the first removable, compressible massage tip 130 in the direction of the first removable head insert slots 124. Based on this compression, the plurality of the first removable, compressible massage tips 130 can conform to any surface of the user's body while pressed perpendicular to the surface of the user's body to be massaged, as shown in FIG. 19.

Each of the first removable, compressible massage tips 130 also can comprise a first removable, compressible massage tip ball bearing 134 to be placed inside the first removable, compressible massage tip head 132. The first removable, compressible massage tip ball bearing 134 allows the first removable, compressible massage tips 130 to glide across any surface of the user's body in an omnidirectional fashion. Further, the first removable, compressible massage tip ball bearings 134 may be either compressible, semi-compressible, or entirely firm based on the material used.

Due to the compartmental nature of the first exemplary embodiment of the ergonomic electric massager 100, a multitude of alternative exemplary embodiments can be implemented. For instance, the first removable, compressible massage tip springs, not shown, can be removed, and the first removable, compressible massage tip base 136 can be solid preventing the first removable, compressible massage tip 130 to pass through the first removable, compressible massage tip base 136 and into the first removable head insert slots 124. In this exemplary embodiment, the material used to construct the first removable, compressible massage tips 130 can either be extremely rigid—for example, polymers, metals, metal alloys, or woods—or can be made out of a semi compressible material that would allow for the first removable, compressible massage tips 130 to compress slightly when a force is applied in the direction of the first removable head insert slots 124—for example, rubber-like polymers—or the first removable, compressible massage tips 130 can be fairly soft and compressible with some internal materials to maintain and return to a structure—for example a sort of compressible foam surrounding a spring. These materials may also be found in any and all exemplary embodiments of the first removable, compressible massage tips 130. Additionally, alternative embodiments of the first removable, compressible massage tips 130 may be employed that use versions of first removable, compressible massage tip heads 132 that lack a first removable, compressible massage tip ball bearing 134. In such an alternative embodiment, the first removable, compressible massage tip head 132 may be either flat or spherical in nature. Further, the first removable, compressible massage tips 130 need not be uniform and each individual first removable, compressible massage tip 130 can vary in size, length, and/or color.

FIGS. 6-7 detail the first removable head 120 in the first exemplary embodiment of the ergonomic electric massager 100. More specifically, FIG. 6 details a top-down perspective regarding the first removable head 120 and FIG. 7 details a bottom-up perspective regarding the first removable head 120. The first removable head 120 can comprise a first removable head top side 122, as shown in FIG. 6; a plurality of first removable head insert slots 124, as shown in FIG. 6; a first removable head back side 126, as shown in FIG. 7; and a first removable head connector 128, as shown in FIG. 7. A first removable, compressible massage tips 130 can be inserted into the first removable head insert slots 124 and the first removable, compressible massage tip base 136 can engage with the first removable head insert slots 124 by the first, removable, compressible massage tip connector 138. The form of engagement can be any sort of engagement that allows the first removable, compressible massage tip connector 138 to remain securely attached to the first removable head insert slot 124, including, but not limited to, a screw thread engagement, as shown in FIG. 6. The first removable head connector 128, can engage with the first body 110. The form of engagement can be any sort of engagement that allows the first removable head connector 128 to remain securely attached to the first body 110, including, but not limited to, a screw thread engagement, as shown in FIG. 8.

The shape of the first removable head 120 between the first removable head top side 122 and the first removable head back side 126 can be that of a uniform convex contour complementary to that of the at least one first body convex contour 112, as shown in FIGS. 1-3. In alternative exemplary embodiments, the first removable head 120 can have various shapes. The first removable head 120 can be removed from the first body 110 and replaced with alternate heads.

FIG. 8 details the first body 110 in the first exemplary embodiment of the ergonomic electric massager 100. The first body 110 can comprise at least one first body concave contour 114, as shown in FIGS. 1-3; at least one first body convex contour 112, as shown in FIGS. 1-3; a first body top side 116, as shown in FIG. 8; a first body bottom side, not shown; a head connector slot 118, as shown in FIG. 8; and a back plate connector slot, not shown. The removable back plate 102 can comprise a removable back plate bottom side, not shown; and a removable back plate connector, not shown.

The first body 110 when engaged with the removable back plate 102 can be designed to have a smooth uniform curvature resembling the shape of a hyperbolic hyperboloid in congruence to a paraboloid, as shown in FIGS. 1-3. The shape of the first body 110 can have at least one first body concave contour 114, as shown in FIGS. 1-3; at least one first body convex contour 112, as shown in FIGS. 1-3 so that the body can be comfortably placed and rolled along various parts of the user's body. In alternative exemplary embodiments, the first body 110 and the removable back plate 102 can have various shapes. Further, due to the vibration action of the motor, the first body 110 itself can be used to massage parts of the user's body, and due to the at least one first body convex contour 112, at least one first body concave contour 114, and the shape of the removable back plate 102, any portion of the first exemplary embodiment of the ergonomic electric massager 100 can massage the user's body.

Inside the first exemplary embodiment of the ergonomic electric massager 100 can be a circuit, not shown, connecting a power supply, not shown, to a motor, not shown, and a switch, not shown. The circuit can comprise any number of resistors, capacitors, transistors, parallel circuits, and sequential circuits to make operation of the first exemplary embodiment of the ergonomic electric massager 100 run as efficiently as possible. The power supply may be any sort of portable power supply including, but not limited to, lead-acid, zinc-air, nickel-cadmium, nickel-metal hydride, lithium-ion, lithium iron phosphate, and lithium-ion polymer. The power supply may be either disposable in nature or rechargeable in nature. The motor may be any sort of compact and portable motor that allows for the vibration of the first exemplary embodiment of the ergonomic electric massager 100. Alternatively, the motor may operate a separate vibrating device, wherein the vibrating device may be either electric, mechanical, or electromechanical in nature. Further, the circuit, not shown, may have any number of sub-circuits, not shown, to allow the user to vary the strength in vibration. Any technique to vary in strength of the vibrations may be employed, including, but not limited to, using parallel circuits to amplify the current of the circuit and using this amplified current to signal the motor to increase the rpms of its moving components. In such an embodiment, the switch, not shown, may be a rotating dial instead of a singular flip switch to allow the user to turn on the first exemplary embodiment of the ergonomic electric massager 100 and then cycle through the various vibration settings before switching the first exemplary embodiment of the ergonomic electric massager 100 off.

The first body 110 can be a hollow shell, as shown in FIG. 8, with access to the internal components of the first exemplary embodiment of the ergonomic electric massager 100 made available either from the first body top side 116, as shown in FIG. 8, or from the first body bottom side, not shown.

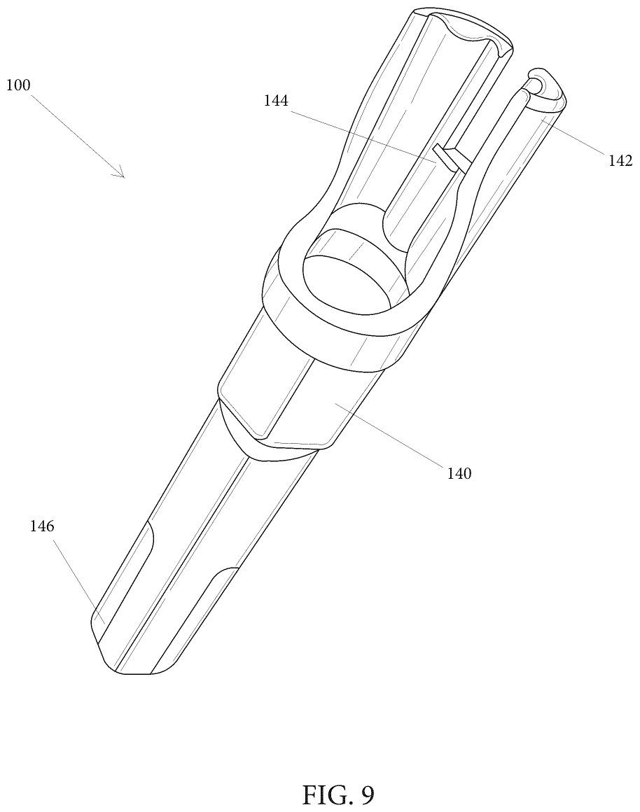

FIGS. 9-10 detail a removable, compressible massage tip remover 140 in the first exemplary embodiment of the ergonomic electric massager 100. The removable, compressible massage tip remover 140 can comprise a removable, compressible massage tip remover tip connecting end 142, a removable, compressible massage tip remover tip base groove 144, and a removable, compressible massage tip remover hand grip 146, as shown in FIG. 9. The removable, compressible massage tip remover 140 can assist users with the removal of first removable, compressible massage tips 130 from the first exemplary embodiment of the ergonomic electric massager 100 as well as second removable, compressible massage tips 220 from the second exemplary embodiment of the ergonomic electric massager 200.

The removable, compressible massage tip remover tip connecting end 142 is placed over the first removable, compressible massage tip head 132 until the removable, compressible massage tip remover tip base groove 144 makes contact with the first removable, compressible massage tip base 136, as shown in FIG. 10. Then the user merely has to rotate the removable, compressible massage tip remover 140 as the removable, compressible massage tip remover tip base groove 144 is engaged with the first removable, compressible massage tip base 136 allowing the first removable, compressible massage tip 130 to disengage from the first removable head insert slot 124. In alternate embodiments, where the form of engagement between the first removable, compressible massage tip connector 138, and the first removable head insert slot 124 is something other than a screw thread, the removable, compressible massage tip remover 140 will be altered accordingly. For example, if the form of engagement is a clip-in system where the connector has retractable components with lips that hook into the walls of the first removable head insert slots 124, then the removable, compressible massage tip remover tip base groove 144 will be able to fit into the gap between the first removable head 120 and the first removable, compressible massage tip connector 138 to depress these retractable components and simply pull the first removable, compressible massage tip 130 out of the first removable head insert slot 124. All of these embodiments may also be applied to the second removable, compressible massage tips 220.

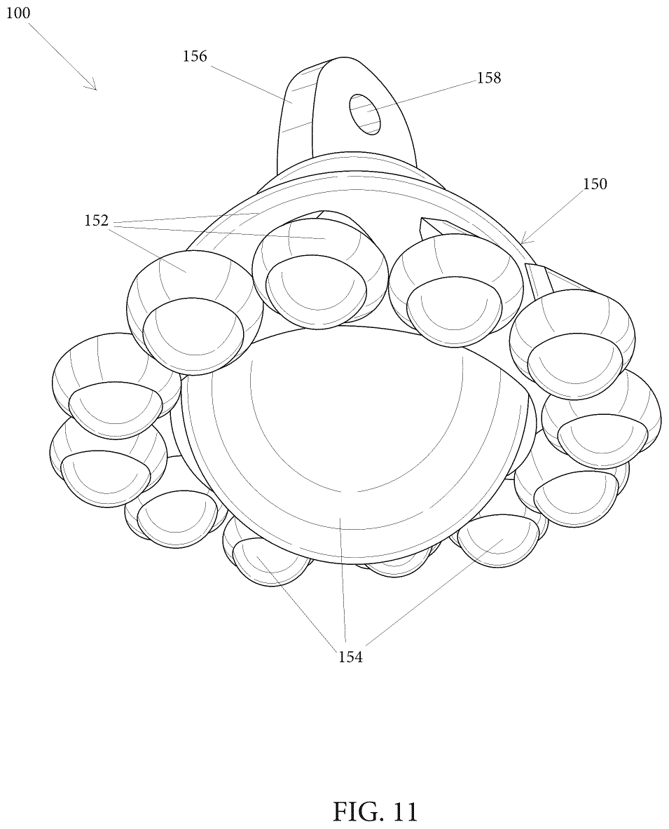

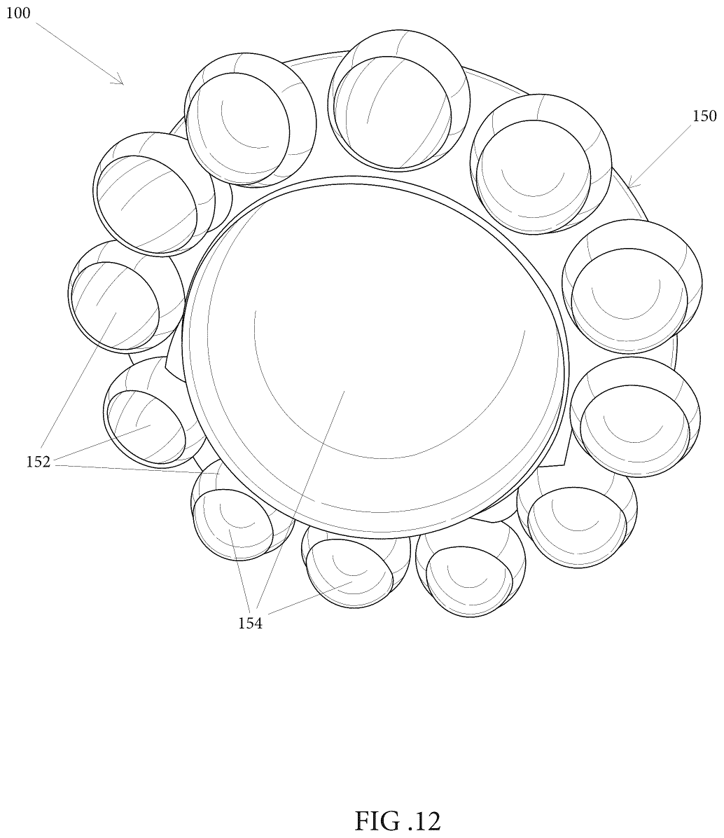

FIGS. 11-12 detail a second removable head 150 as well as its components in the first exemplary embodiment of the ergonomic electric massager 100. The second removable head 150 can comprise second removable head insert slots 152, second removable head ball bearings 154, a second removable head connecting end 156, and a second removable head connecting end through hole 158. Alternatively, the second removable head 150 can have a second removable head back side, not shown, and a second removable head connector, not shown, in replace of the second removable head connecting end 156 and the second removable head connecting end through hole 158. Similarly, the first removable head 120 can have a first removable head connecting end, not shown, and a first removable head connecting end through hole in replace of the first removable head back side 126 and the first removable head connector 128. Further, any other removable heads that may be used and may also have either a back side and a connector, similar to that of the first removable head 120, as shown in FIG. 7, or have a connecting end and a connecting end through hole, similar to that of the second removable head 150 as shown in FIG. 11.

Instead of removable, compressible massage tips, the second removable head 150 can comprise a multitude of second removable head ball bearings 154 that can fit inside respective second removable head insert slots 152. The second removable head ball bearings 154 may be either compressible, semi-compressible, or entirely firm based on the material used, and may vary in size and/or color along with their respective second removable head insert slot 152, as shown in FIG. 11. The second removable head ball bearings 154 allow the second removable head 150 to glide across any surface of the user's body in an omnidirectional fashion. Further, the second removable head ball bearings 154 can be fully removed, as shown in FIG. 12, and/or interchanged with alternative versions of the second removable head ball bearings 154. Additionally, alternative embodiments of the second removable head 150 may be employed that use massage components, not shown, that are not ball bearings in replacement of the second removable head insert slots 152 and second removable head ball bearings 154. In such an alternative embodiment, the massage components, not shown be either flat or spherical in nature.

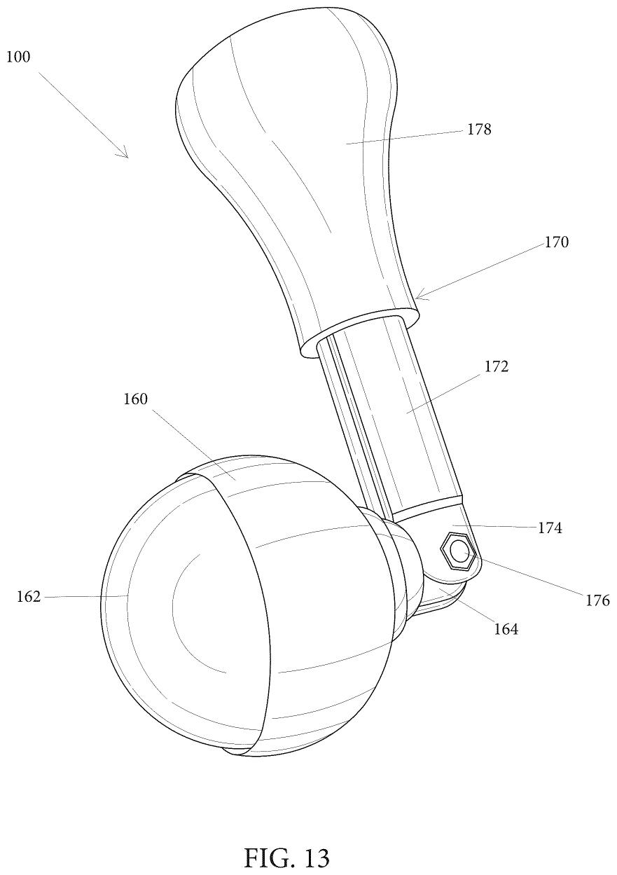

FIG. 13 details a third removable head 160 and a first neck attachment 170 in the first exemplary embodiment of the ergonomic electric massager 100. The third removable head 160 can comprise a third removable head ball bearing 162, a third removable head connecting end 164, and a third removable head connecting end through hole, not shown. The first neck attachment 170 can comprise a first neck attachment extendable neck 172, a first neck attachment head connecting port 174, a first neck attachment head fastener 176, and a first neck attachment body connecting port 178.

The third removable head 160 can comprise at least a singular slot to hold the third removable head ball bearing 162, as shown in FIG. 13, and the third removable head connecting end 164 attaches to the first neck attachment 170 by securely fastening the third removable head connecting end through hole, not shown, to the first neck attachment head connecting port 174 by a first neck attachment head fastener 176. The first neck attachment head fastener 176 can be any such fastening system to secure the placement of the third removable head 160 including, but not limited to, any combination of screws, bolts, nuts, and washers; nails; pins; and the like. Further, the first neck attachment head connecting port 174 can accept the second removable head connecting end 156 in addition to any other removable head that has a connecting end and connecting end through hole.

Additionally, any removable head connected to the first neck attachment 170 can be set at any desired angle ranging from 0 degrees to 180 degrees around the first neck attachment head fastener 176. For instance, as shown in FIG. 13, if the first neck attachment head fastener 176 was placed at the origin of a traditional cartesian coordinate plane in conjunction with the standard unit circle, the third removable head 160 can be described as having a 0 degree angle along the x-axis as shown in FIG. 13. From there, the first neck attachment head fastener 176 can be adjusted to a 45 degree angle, straightened to a 90 degree angle, adjusted to a 135 degree angle, or adjusted to a 180 degree angle, or any other angle in between the values listed. Further, setting the removable heads in place can either be rigid or semi-rigid in nature, where the head cannot be removed and/or readjusted without first unfastening the first neck attachment head fastener 176 in a rigid system and the head can be adjusted but not removed without first unfastening the first neck attachment head fastener 176 in a semi-rigid system.

Further, the first neck attachment extendable neck 172 can be adjusted to various lengths, with the first neck attachment extendable neck 172 capable of retracting into the first neck attachment body connecting port 178. In one embodiment, the maximum extension length of the first neck attachment extendable neck 172 is equal to that of the length of the first neck attachment body connecting port 178 and the minimum extension length of the first neck attachment extendable neck 172 is zero since the entirety of the first neck attachment extendable neck 172 is stored inside the first neck attachment body connecting port 178. In an alternative embodiment, the minimum extension length of the first neck attachment extendable neck 172 is equal to some length away from the first neck attachment body connecting port 178, defined as “1”, with the maximum extension length of the first neck attachment extendable neck 172 is equal to/plus the length of the first neck attachment body connecting port 178—i.e., the length already extended plus the amount stored within the first neck attachment body connecting port 178. In an alternative embodiment, the length of the first neck attachment extendable neck 172 that can be stored within the first neck attachment body connecting port 178 may be less than that of the length of the first neck attachment body connecting port 178.

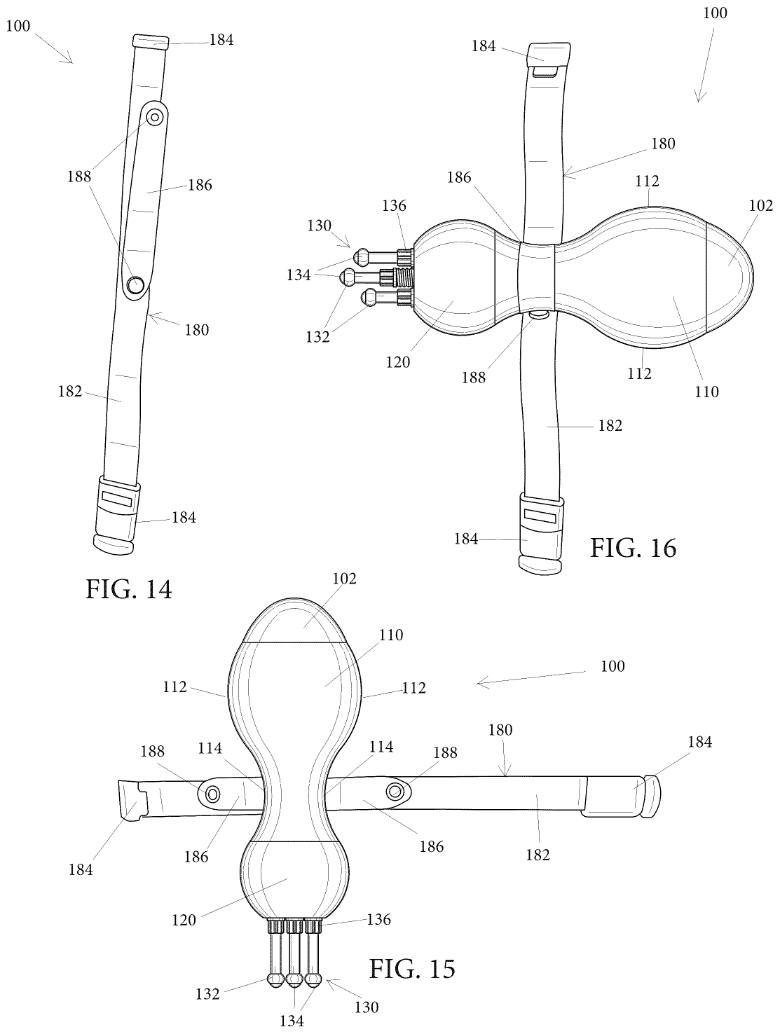

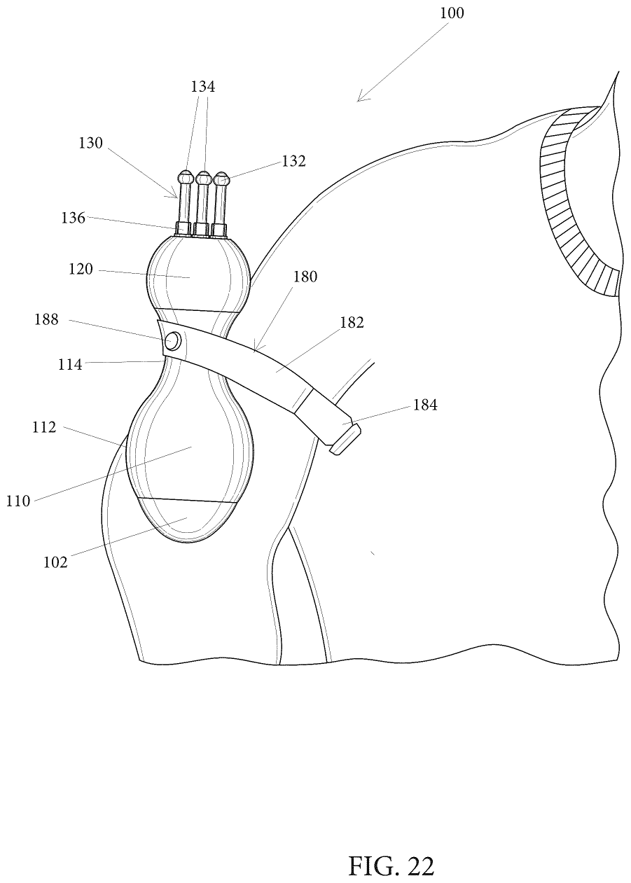

FIGS. 14-16 detail a first strap attachment 180 to be used on first exemplary embodiment of the ergonomic electric massager 100. The first strap attachment 180 may comprise a first outer strap 182 and a first inner strap 186. The first outer strap 182 may be connected to the first inner strap 186 by the first inner strap fastener 188. The first inner strap may be affixed to the first exemplary embodiment of the ergonomic electric massager 100 and secured by the first inner strap fastener 188, as shown in FIGS. 15-16. The first outer strap may be affixed to the user's body and secured by the first outer strap fastener 184, as shown in FIGS. 22-27. The first inner strap fastener 188 may be any sort of fastening device such as a snap button or screw-head engagement. The first outer strap fastener 184 may be any sort of fastening device such as a snap button or screw-head engagement.

In an alternative exemplary embodiment, the first inner strap 182 and the first outer strap 186 are replaced with a first singular strap, not shown. The first singular strap, not shown, may have at least two contorting strap ends, not shown, to allow a first strap end, not shown, to fasten around the first exemplary embodiment of the ergonomic electric massager 100 and a second strap end, not shown, to fasten around the user's body.

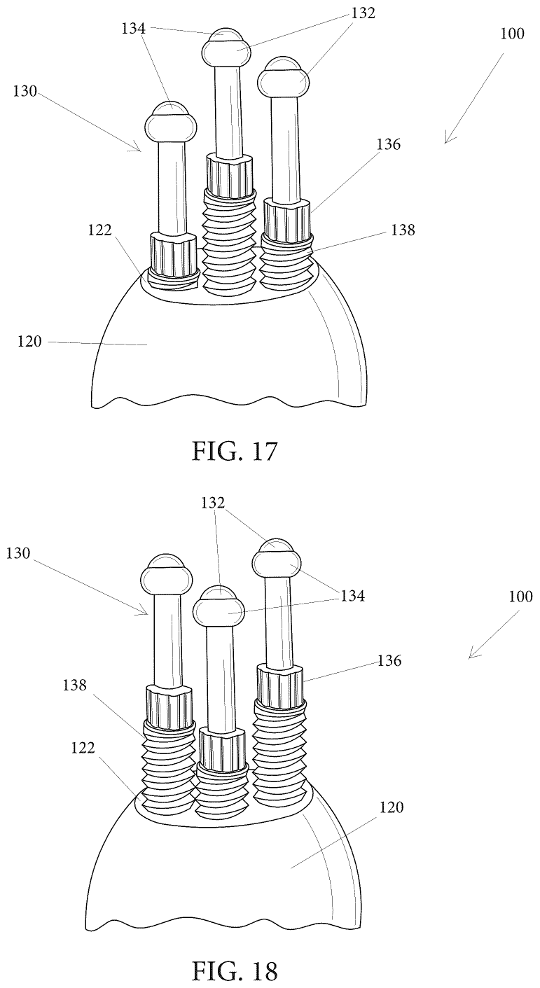

FIGS. 17-18 further detail the plurality of first removable, compressible massage tips 130—as well as their components—in the first exemplary embodiment of the ergonomic electric massager 100. The plurality of first removable, compressible massage tips 130 can be inserted into the plurality of first removable head insert slots 124. The plethora of first removable, compressible massage tips 130 can each comprise a first removable, compressible massage tip head 132; a first removable, compressible massage tip ball bearing 134; a first removable, compressible massage tip base 136; a first removable, compressible massage tip connector 138, as shown in FIG. 10, and a first removable, compressible massage tip spring, not shown.

For each of the first removable, compressible massage tips 130, the first removable, compressible massage tip spring, not shown, can be placed inside a first removable head insert slot 124, and then the first removable, compressible massage tip base 136 can be engaged with first removable head insert slot 124 by the first removable, compressible massage tip connector 138. The form of engagement can be any sort of engagement that allows the first removable, compressible massage tip connector 138 to remain securely attached to the first removable head insert slot 124, including, but not limited to, a screw thread engagement. Each first removable, compressible massage tip base 136 and first removable, compressible massage tip connector 138 can be hollow allowing for the first removable, compressible massage tip 130 to move through the first removable, compressible massage tip base 136 and into the first removable head insert slot 124 up to the first removable, compressible massage tip head 132. Thus, each of the first removable, compressible massage tips 130 can be compressed into a first removable head insert slot 124 up to the first removable, compressible massage tip head 132 when a force is applied to the first removable, compressible massage tip 130 in the direction of the first removable head insert slots 124. Based on this compression, the plurality of the first removable, compressible massage tips 130 can conform to any surface of the user's body while pressed perpendicular to the surface of the user's body to be massaged, as shown in FIG. 19.

Each of the first removable, compressible massage tips 130 also can comprise a first removable, compressible massage tip ball bearing 134 to be placed inside the first removable, compressible massage tip head 132. The first removable, compressible massage tip ball bearing 134 allows the first removable, compressible massage tips 130 to glide across any surface of the user's body in an omnidirectional fashion. Further, the first removable, compressible massage tip ball bearings 134 may be either compressible, semi-compressible, or entirely firm based on the material used.

Due to the compartmental nature of the first exemplary embodiment of the ergonomic electric massager 100, a multitude of alternative exemplary embodiments can be implemented. For instance, the first removable, compressible massage tip springs, not shown, can be removed, and the first removable, compressible massage tip base 136 can be solid preventing the first removable, compressible massage tip 130 to pass through the first removable, compressible massage tip base 136 and into the first removable head insert slots 124. In this exemplary embodiment, the material used to construct the first removable, compressible massage tips 130 can either be extremely rigid—for example, polymers, metals, metal alloys, or woods—or can be made out of a semi compressible material that would allow for the first removable, compressible massage tips 130 to compress slightly when a force is applied in the direction of the first removable head insert slots 124—for example, rubber-like polymers—or the first removable, compressible massage tips 130 can be fairly soft and compressible with some internal materials to maintain and return to a structure—for example a sort of compressible foam surrounding a spring. These materials may also be found in any and all exemplary embodiments of the first removable, compressible massage tips 130. Additionally, alternative embodiments of the first removable, compressible massage tips 130 may be employed that use versions of first removable, compressible massage tip heads 132 that lack a first removable, compressible massage tip ball bearing 134. In such an alternative embodiment, the first removable, compressible massage tip head 132 may be either flat or spherical in nature. Further, the first removable, compressible massage tips 130 need not be uniform and each individual first removable, compressible massage tip 130 can vary in size, length, and/or color.

Additionally, the first removable, compressible massage tip connector 138 need not be fully engaged with the first removable head insert slots 124, allowing the first removable, compressible massage tip heads 132 to be positioned at varying distances away from the first removable head top side 122, as shown in FIGS. 17-18. Further, not every first removable head insert slot 124 needs to be fitted with a first removable, compressible massage tip 130, as shown in FIGS. 5 and 17-18. By adjusting the degree of engagement between the first removable, compressible massage tip connector 138 and the first removable head insert slot 124, as well as the number of first removable, compressible massage tips 130 engaged with first removable head top side 122, the first removable, compressible massage tips 130 can be arranged to contort to any portion of the user's body without the need of compressing the first removable, compressible massage tips 130. This configuration may be quite useful for the exemplary embodiment where the first removable, compressible massage tips 130 are made out of either non-compressible material or semi-compressible material.

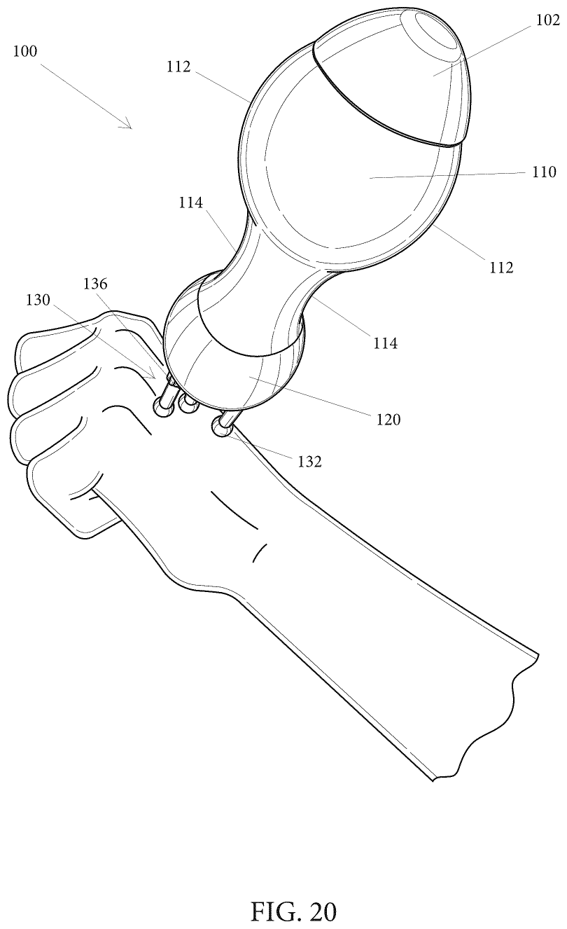

FIGS. 19-27 detail the application of in the first exemplary embodiment of the ergonomic electric massager 100. In FIG. 19, the plurality of first removable, compressible massage tips 130 are applied to the user's outer knee in a direction perpendicular to the user's outer knee, and in FIG. 20, the plurality of first removable, compressible massage tips 130 are applied to the user's hand in a direction perpendicular to the user's hand. In FIGS. 19-20, a downward normal force is applied by the first exemplary embodiment of the ergonomic electric massager 100 onto the user's body, causing an equal and opposite normal force to be applied onto the first removable, compressible massage tips 130. This in turn causes the first removable, compressible massage tips 130 to retract into the first removable head insert slots 124, allowing the first removable, compressible massage tips 130 to conform to the shape of the user's outer knee and hand. Due to the first removable, compressible massage tip ball bearings 134, the first exemplary embodiment of the ergonomic electric massager 100 may glide along the user's outer skin to aid in the application of the massage. When the switch connected to the internal circuit is switched on, the first exemplary embodiment of the ergonomic electric massager 100 will vibrate thereby massaging the user's body. When the user is finished massaging their outer knee and/or hand, the user may then set the switch to off, disconnecting the circuit and stopping the vibration action. When the user lifts the first exemplary embodiment of the ergonomic electric massager 100 from either their outer knee or hand, the first removable, compressible massage tips 130 will return back to their original positions prior to being compressed. This embodiment can be applied to any other part of the user's body.

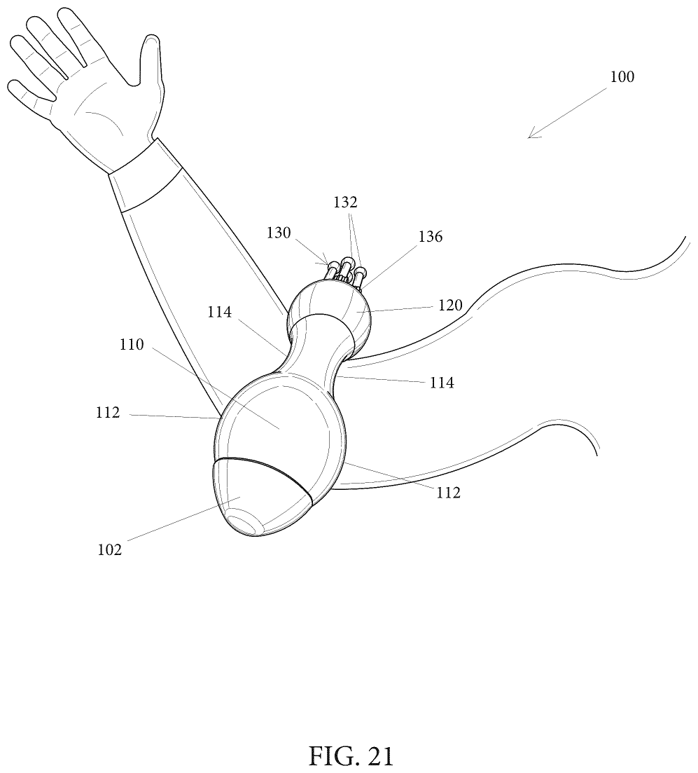

In FIG. 21, the at least one first body concave contour 114 is applied to the user's inner elbow. The curvature of the first body 110 allows for the first exemplary embodiment of the ergonomic electric massager 100 to lay comfortably in certain crevices along the user's body, such as the inner elbows, armpits, inner knees, and neck-shoulder joints. When the first exemplary embodiment of the ergonomic electric massager 100 is placed inside the user's inner elbow, as shown in FIG. 21, the user may bend their elbow to force the first exemplary embodiment of the ergonomic electric massager 100 to be applied into their skin and muscles more deeply. Due to the curvature of the first body 110, the first exemplary embodiment of the ergonomic electric massager 100 may be rolled along the user's arm to aid in the application of the massage. When the switch connected to the internal circuit is switched on, the first exemplary embodiment of the ergonomic electric massager 100 may vibrate thereby massaging the user's inner elbow. When the user is finished massaging their inner elbow, the user may then set the switch to off, disconnecting the circuit and stopping the vibration action. This embodiment can be applied to other parts of the user's body.

FIGS. 22-27 detail another exemplary embodiment, where the first strap attachment 180 may be employed to affix the first exemplary embodiment of the ergonomic electric massager 100 to the user's body. In particular, the first inner strap 186 may be fastened around the first exemplary embodiment of the ergonomic electric massager 100 and fastened by the first inner strap fastener 188 and the first outer strap 182 may be fastened around the user's body, as shown in FIGS. 22-27, and fastened with the first outer strap fastener 184. The first inner strap 186 may be attached to the first outer strap 182 by the first inner fastener 188.

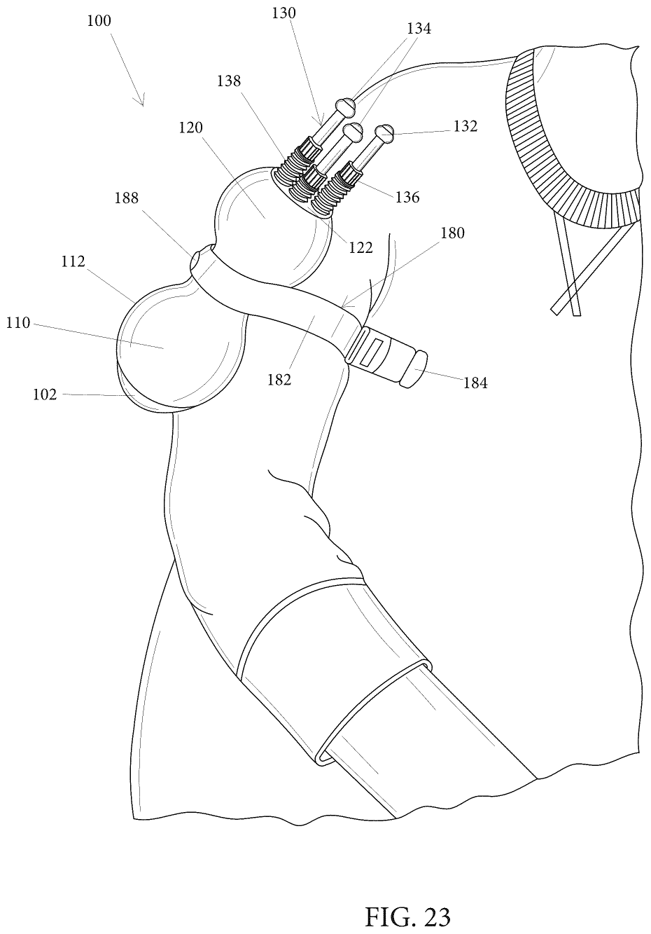

In FIGS. 22-23, the first exemplary embodiment of the ergonomic electric massager 100 is strapped to the user's upper outer arm by the first outer strap 182. When the first inner strap 186 is attached to the first exemplary embodiment of the ergonomic electric massager 100, the first inner strap 186 is attached to the first outer strap 182, and the first outer strap 182 is attached to the user's upper outer arm, the user may turn the switch on to activate the vibration of the first exemplary embodiment of the ergonomic electric massager 100 and massage their upper outer arm muscles hands free.

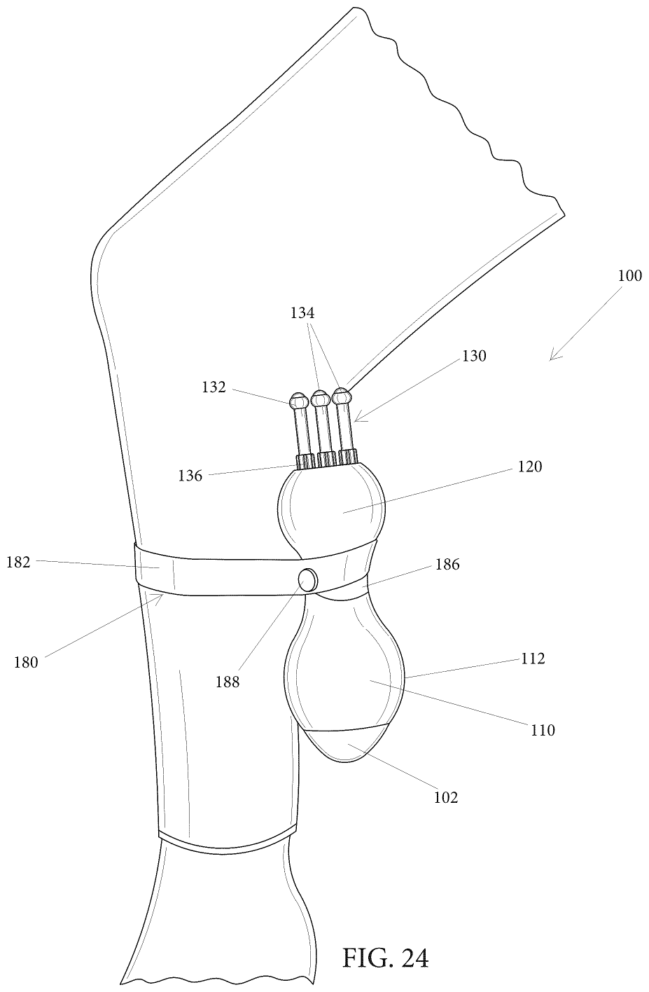

In FIG. 24, the first exemplary embodiment of the ergonomic electric massager 100 is strapped to the user's calf by the first outer strap 182. When the first inner strap 186 is attached to the first exemplary embodiment of the ergonomic electric massager 100, the first inner strap 186 is attached to the first outer strap 182, and the first outer strap 182 is attached to the user's calf, the user may turn the switch on to activate the vibration of the first exemplary embodiment of the ergonomic electric massager 100 and massage their calf muscles hands free.

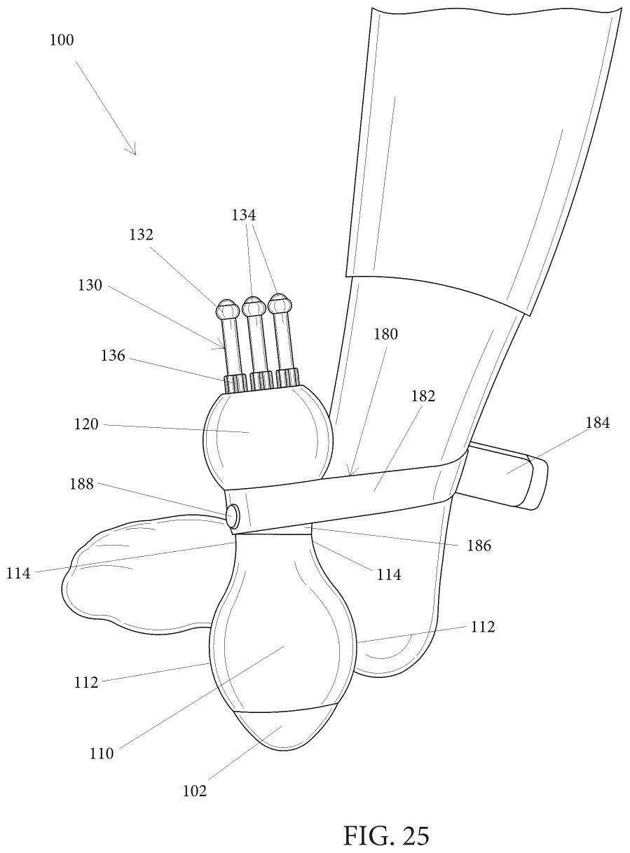

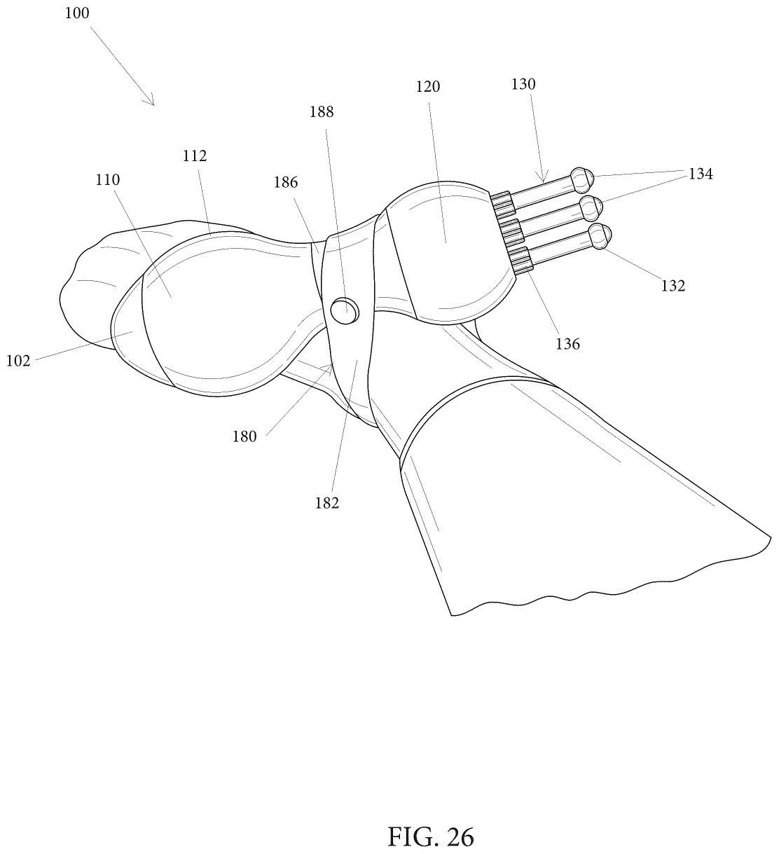

In FIGS. 25-26, the first exemplary embodiment of the ergonomic electric massager 100 is strapped to the user's ankle by the first outer strap 182. When the first inner strap 186 is attached to the first exemplary embodiment of the ergonomic electric massager 100, the first inner strap 186 is attached to the first outer strap 182, and the first outer strap 182 is attached to the user's ankle, the user may turn the switch on to activate the vibration of the first exemplary embodiment of the ergonomic electric massager 100 and massage their ankle muscles hands free.

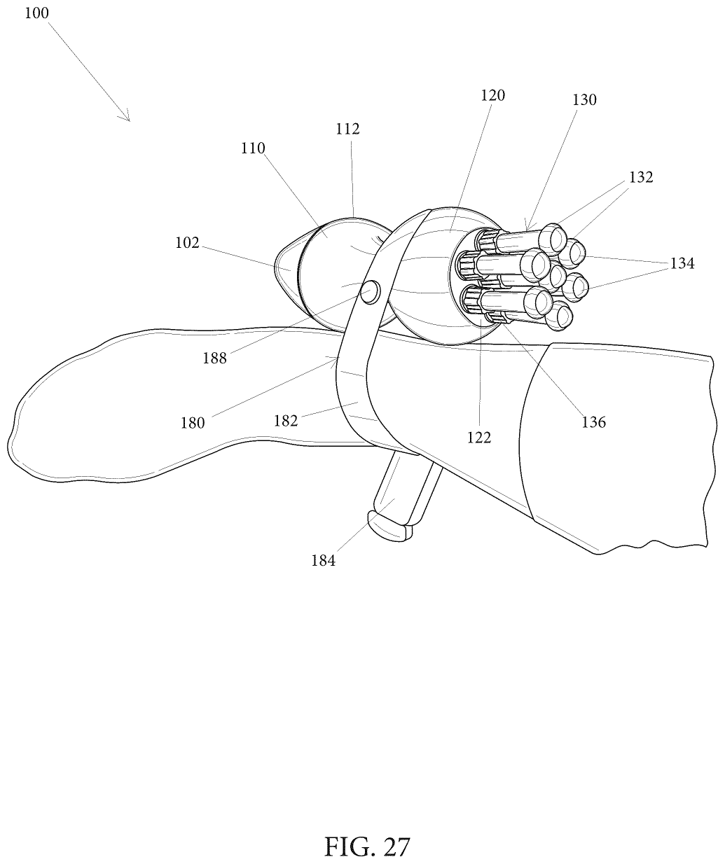

In FIGS. 27, the first exemplary embodiment of the ergonomic electric massager 100 is strapped to the user's lower leg by the first outer strap 182. When the first inner strap 186 is attached to the first exemplary embodiment of the ergonomic electric massager 100, the first inner strap 186 is attached to the first outer strap 182, and the first outer strap 182 is attached to the user's lower leg, the user may turn the switch on to activate the vibration of the first exemplary embodiment of the ergonomic electric massager 100 and massage their lower leg muscles hands free.

In an alternative exemplary embodiment, other parts of the first exemplary embodiment of the ergonomic electric massager 100 are used to massage the user's body, for example the removable back plate 102. In this embodiment, the first exemplary embodiment of the ergonomic electric massager 100 is in an orientation opposite that of FIG. 14, with the removable back plate 102 directed at the user's body and applied against the user's skin and muscles. Due to the smooth surface and curvature of the removable back plate 102 and the first body 110 the first exemplary embodiment of the ergonomic electric massager 100 can glide along the user's skin with ease as the vibration action of the internal motor massages the user's muscles.

In another alternative exemplary embodiment, the first exemplary embodiment of the ergonomic electric massager 100 is placed on the floor and the user lays a portion of the body—for instance their gluteus maximus, gluteus medius, iliotibial tract, or biceps femoris—along the first body 110 in order to use the weight of their own body to fully massage their desired muscles. Further, due to the shape of the first body 110, the first exemplary embodiment of the ergonomic electric massager 100 can roll along the ground and along the user's body in order to aid in the massage.

The material of the first body 110, the first removable head 120, the removable back plate 102, removable, compressible massage tip remover 140, the second removable head 150, the third removable head 160, the first neck attachment 170, and other removable heads, not shown, may be made out of, including but limited to, metal, metal alloys and/or polymers.

FIGS. 28-34, detail a second exemplary embodiment of the ergonomic electric massager 200. The second exemplary embodiment of the ergonomic electric massager 200 can comprise a second body 210 which can comprise a second body top side 212, a plethora of second body insert slots 218 a second body side structure 214, a second body bottom side, not shown, and a plethora of second body support screws 216. A plethora of second removable, compressible massage tips 220 can be inserted into the plethora of second body insert slots 218 located along the second body top side 212. Each of the second removable, compressible massage tips 220 can comprise a second removable, compressible massage tip head 222; a second removable, compressible massage tip ball bearing 224; a second removable, compressible massage tip base 226; a second removable, compressible massage tip connector 228; and a second removable, compressible massage tip spring, not shown.

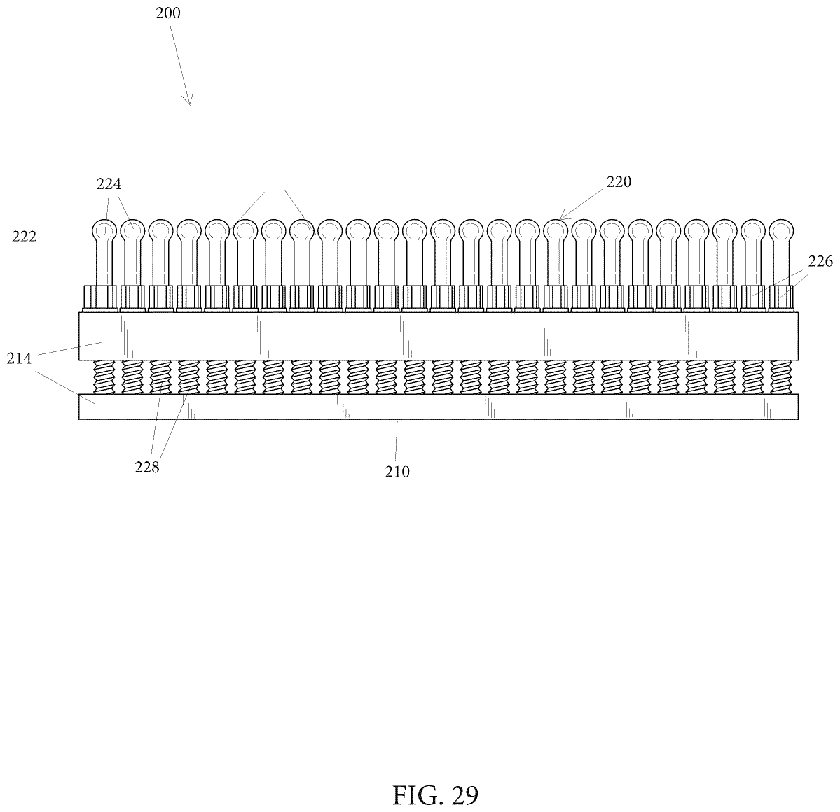

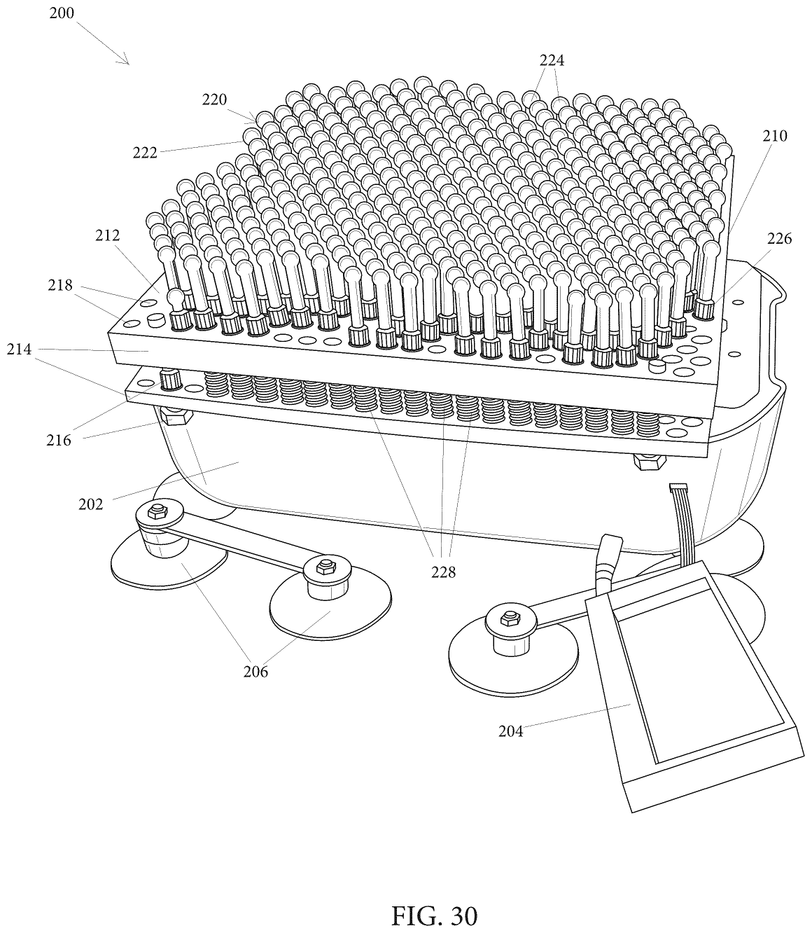

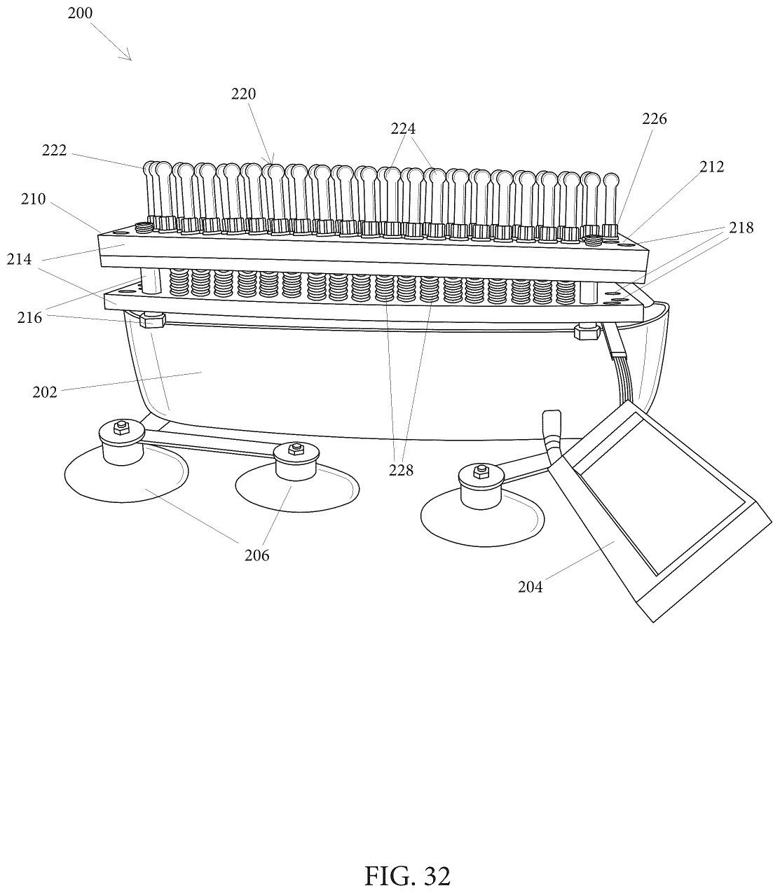

The second body 210 can be designed as a large box-shaped platform that is large and sturdy enough to allow the user to stand atop of it without the structural integrity of the second body 210 failing. In alternative embodiments, the second body 210 can have designs other than a box. In one exemplary embodiment, the second body 210 can have a second body top side 212 and at least four sides. The second body side structure 214 can be a singular side panel or a multitude of smaller side panels placed along the second body top side 212 and the second body bottom side, not shown, in order to save on materials and reduce the overall weight of the second exemplary embodiment of the ergonomic electric massager 200, as shown in FIG. 29. The plethora of second body support screws 216 may be placed at least the corners of the second body 210 to establish the structural integrity of the second body 210, as shown in FIGS. 30 and 32. Second placement fasteners 206 may be employed to ensure the second body 210 does not move during operation.

Underneath the second exemplary embodiment of the ergonomic electric massager 200 can be a circuit, not shown, connecting a second power supply 204 to a motor, not shown, and a switch, not shown. The circuit can comprise any number of resistors, capacitors, transistors, parallel circuits, and sequential circuits to make operation of the second exemplary embodiment of the ergonomic electric massager 200 run as efficiently as possible. The second power supply 204 may be any sort of portable power supply including, but not limited to, lead-acid, zinc-air, nickel-cadmium, nickel-metal hydride, lithium-ion, lithium iron phosphate, and lithium-ion polymer. The second power supply 204 may be either disposable in nature or rechargeable in nature. The motor may be any sort of compact and portable motor that allows for the vibration of the second exemplary embodiment of the ergonomic electric massager 200. Alternatively, the motor may operate a separate second vibrating device 202, wherein the second vibrating device 202 may be either electric, mechanical, or electromechanical in nature. Further, the circuit, not shown, may have any number of sub-circuits, not shown, to allow the user to vary the strength in vibration. Any technique to vary in strength of the vibrations may be employed, including, but not limited to, using parallel circuits to amplify the current of the circuit and using this amplified current to signal the motor to increase the rpms of its moving components. In such an embodiment, the switch, not shown, may be a rotating dial instead of a singular flip switch to allow the user to turn on the second exemplary embodiment of the ergonomic electric massager 200 and then cycle through the various vibration settings before switching the second exemplary embodiment of the ergonomic electric massager 200 off.

For each of the second removable, compressible massage tips 220, the second removable, compressible massage tip spring, not shown, can be first placed inside a second insert slot 218 and then the second removable, compressible massage tip base 226 can be engaged with the second insert slot 218 by the second removable, compressible massage tip connector 228. The form of engagement can be any sort of engagement that allows the second removable, compressible massage tip connector 228 to remain securely attached to the second insert slot 218 including, but not limited to, a screw thread engagement. Each second removable, compressible massage tip base 226 and second removable, compressible massage tip connector 228 can be hollow allowing for the second removable, compressible massage tip 220 to move through the second removable, compressible massage tip base 226 and into the second insert slot 218 up to the second removable, compressible massage tip head 222. Thus, each of the second removable, compressible massage tips 220 can be compressed into a second insert slot 218 up to the second removable, compressible massage tip head 222 when a force is applied to the second removable, compressible massage tip 220 in the direction of the second insert slots 218. Based on this compression, the plurality of the second removable, compressible massage tips 220 can conform to any surface of the user's body while pressed perpendicular to the surface of the user's body to be massaged.

Each of the second removable, compressible massage tips 220 also can comprise a second removable, compressible massage tip ball bearing 224 to be placed inside the second removable, compressible massage tip head 222. The second removable, compressible massage tip ball bearing 224 allows the second removable, compressible massage tips 220 to glide across any surface of the user's body in an omnidirectional fashion. Further, the second removable, compressible massage tip ball bearings 224 may be either compressible, semi-compressible, or entirely firm based on the material used.

Due to the compartmental nature of the second exemplary embodiment of the ergonomic electric massager 200, a multitude of alternative exemplary embodiments can be implemented. For instance, the second removable, compressible massage tip springs, not shown, and the second removable, compressible massage tip connectors 228 can be removed, and the second removable, compressible massage tip base 226 can be solid preventing the second removable, compressible massage tip 220 to pass through the second removable, compressible massage tip base 226 and into the second insert slots 218. In this exemplary embodiment, the material used to construct the second removable, compressible massage tips 220 can either be extremely rigid—for example, polymers, metals, metal alloys, or woods—or can be made out of a semi compressible material that would allow for the second removable, compressible massage tips 220 to compress slightly when a force is applied in the direction of the second insert slots 218—for example, rubber-like polymers—or second removable, compressible massage tips 220 can be fairly soft and compressible with some internal materials to maintain and return to a structure—for example a sort of compressible foam surrounding a spring. These materials may also be found in any and all exemplary embodiments of the second removable, compressible massage tips 220. Additionally, alternative embodiments of the second removable, compressible massage tips 220 may be employed that use versions of second removable, compressible massage tip heads 222 that lack a second removable, compressible massage tip ball bearing 224. In such an alternative embodiment, the second removable, compressible massage tip head 222 may be either flat or spherical in nature. Further, the second removable, compressible massage tips 220 need not be uniform and each individual second removable, compressible massage tip 220 can vary in size, length, and/or color.

A user operates the second exemplary embodiment of the ergonomic electric massager 200 by standing on top of the second body 210. As the user is standing atop the second body 210, the plurality of second removable, compressible massage tips 220 are applied to the user's feet in an upward direction. A downward normal force is applied by user onto the second removable, compressible massage tips 220. This in turn causes the second removable, compressible massage tips 220 to retract into the second insert slots 218 allowing the second removable, compressible massage tips 220 to conform to the shape of the user's feet. Due to the second removable, compressible massage tip ball bearings 224, the second exemplary embodiment of the ergonomic electric massager 200 may glide along the user's outer skin to aid in the application of the massage. When the switch connected to the internal circuit is switched on, the second exemplary embodiment of the ergonomic electric massager 200 will vibrate thereby massaging the user's feet. When the user is finished massaging their feet, the user may then set the switch to off, disconnecting the circuit and stopping the vibration action. When the user steps off of the second exemplary embodiment of the ergonomic electric massager 200, the second removable, compressible massage tips 220 will return back to their original positions prior to being compressed. This embodiment can be applied to any other part of the user's body.

In an alternative exemplary embodiment, the user may lay a portion of the body—for instance their upper back or lower back—along the second body 210 in order to use the weight of their own body to fully massage their desired muscles. Further, due to the size of the second body 210, the second exemplary embodiment of the ergonomic electric massager 200 can remain in place as the user glides their body along the second removable, compressible massage tip ball bearings 224 in order to aid in the massage.

The material of the second body 210 may be made out of, including but limited to, metal, metal alloys and/or polymers.

FIG. 35 details a second foot matt 240 accessory that may be placed atop of the second body 210. In one exemplary embodiment, the second foot matt 240 may comprise a general outline of the user's feet as well as any other information, images, and/or colors, such as the muscles of the foot or arbitrary images of the user's internal organs. In an alternative exemplary embodiment, the second foot matt 240 is replaced with separate feet matts, not shown, wherein each separate foot matt details either the user's left foot or right foot individually.

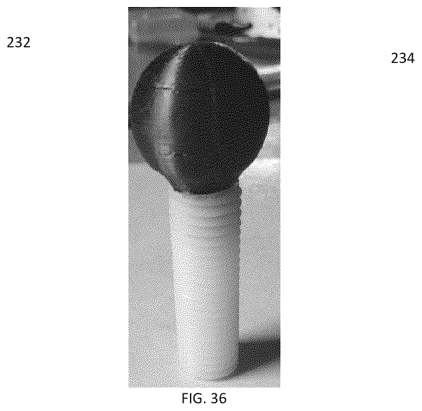

FIG. 36 is an exemplary removable head 232 that is noncompressible and comprises a solid and immovable tip 234.

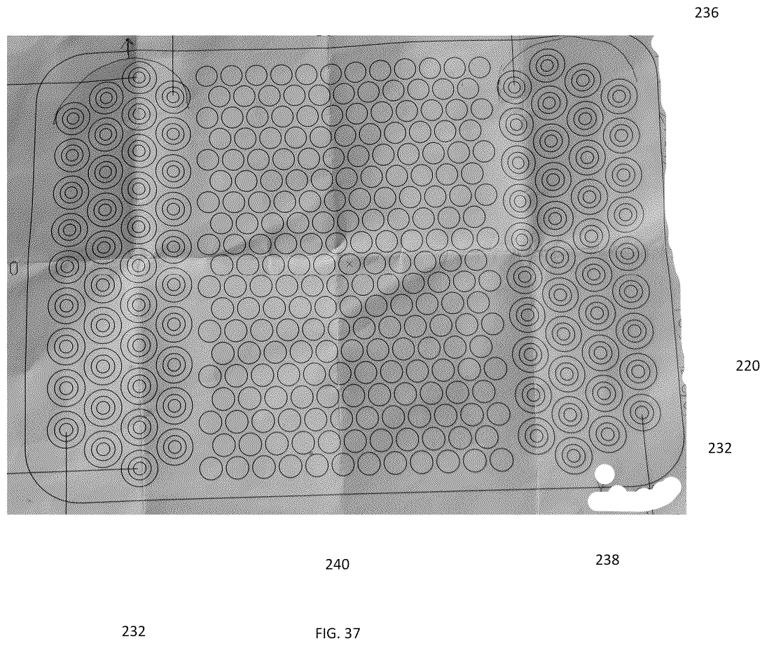

FIG. 37 is a schematic for a third exemplary embodiment of the ergonomic electric massager 236 that comprises the majority of the elements of the second exemplary embodiment of the ergonomic electric massager 200. The third exemplary embodiment of the ergonomic electric massager 236 can comprise a plurality of removable heads 232 that are noncompressible. Each of the plurality of removable heads 232 comprise an immovable tip 234. The immovable tip 234 can be 25% to 75% bigger than the second removable, compressible massage tip 220. The plurality of removable heads 232 can be placed in the first 2 to 4 rows (4 rows illustrated) of the outer edge 238. The second removable, compressible massage tips 220 can be placed in the central region 240 of the ergonomic electric massager 236.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. An electric massager comprising:
a housing body, wherein the housing body further comprises a first front end and a rear end and the first front end is removable;
a power supply, wherein the power supply is stored inside the housing body;
a motor, wherein the motor is stored inside the housing body and is connected to the power supply by a circuit with a switch;
a removable head comprising a plurality of removable, compressible massage tips, wherein the removable head is attached to the first front end of the housing body; and
an activation mechanism, wherein the activation mechanism engages the switch of the circuit and the activation mechanism is attached to the rear end of the housing body.

2. The electric massager of claim 1, wherein a first portion of the housing body resembles a hyperbolic hyperboloid.

3. The electric massager of claim 2, wherein a second portion of the housing body resembles a paraboloid.

4. The electric massager of claim 1, further comprising a second front end wherein the second front end may be attached to the housing body when the first front end is removed from the housing body.

5. The electric massager of claim 4, further comprising at least one removable, slidable head, wherein the at least one removable, slidable head is inserted into the second front end of the housing body.

6. The electric massager of claim 1, wherein the circuit further comprises a plurality of parallel circuits and a plurality of additional switches attached to the parallel circuits.

7. The electric massager of claim 6, wherein the activation mechanism further engages the additional switches of the circuit.

8. The electric massager of claim 4, wherein the first front end further comprises an adjustable pivot head and the second front end further comprises an adjustable pivot head.

9. The electric massager of claim 1, further comprising a plurality of springs, wherein the plurality of springs are placed between the plurality of removable, compressible heads and the first front end of the housing body.

10. The electric massager of claim 1, wherein the tip of each removable, compressible massage tip further comprises a ball bearing.

11. The electric massager of claim 6, wherein each removable, slidable head is a ball bearing.

12. An electric massager comprising:
a housing body, wherein the housing body further comprises a top and a bottom opposite from the top, and at least four sides that connect the top to the bottom;
a power supply, wherein the power supply is stored inside the housing body;
a motor, wherein the motor is stored inside the housing body and is connected to the power supply by a circuit with a switch;
a plurality of removable, compressible heads, wherein the plurality of removable, compressible heads are inserted into the top of the housing body and each removable, compressible head further comprises a tip; and
an activation mechanism, wherein the activation mechanism engages the switch of the circuit and the activation mechanism is attached to one of the at least four sides of the housing body.

13. The electric massager of claim 12, wherein the circuit further comprises a plurality of parallel circuits and a plurality of additional switches attached to the parallel circuits.

14. The electric massager of claim 13, wherein the activation mechanism further engages the additional switches of the circuit.

15. The electric massager of claim 12, further comprising a plurality of springs, wherein the plurality of springs are placed between the plurality of removable, compressible heads and the top of the housing body.

16. The electric massager of claim 12, wherein the tip of each removable, compressible heads further comprises a ball bearing.

17. An electric massager comprising:
a housing body, wherein the housing body further comprises a top and a bottom opposite from the top, and at least four sides that connect the top to the bottom;
a power supply, wherein the power supply is stored inside the housing body;
a motor, wherein the motor is stored inside the housing body and is connected to the power supply by a circuit with a switch;
a plurality of removable heads, each removable head further comprising an immovable tip, wherein the plurality of removable heads are noncompressible and inserted into the top of the housing body at the outer edge;
a plurality of removable, compressible heads, wherein the plurality of removable, compressible heads are inserted into the top of the housing body in a central region and each removable, compressible head further comprises a tip;
an activation mechanism, wherein the activation mechanism engages the switch of the circuit and the activation mechanism is attached to one of the at least four sides of the housing body.

18. The electric massager of claim 17, wherein the circuit further comprises a plurality of parallel circuits and a plurality of additional switches attached to the parallel circuits.

19. The electric massager of claim 17, wherein the activation mechanism further engages the additional switches of the circuit.

20. The electric massager of claim 17, wherein the tip of each of the removable heads is 25% to 75% bigger than the tip of the removable, compressible heads.
